(19) United States
(12) Patent Application Publication
(10) Pub. No.: US 2010/0264371 A1
(43) Pub. Date: Oct. 21, 2010

(54) COMPOSITION INCLUDING QUANTUM DOTS, USES OF THE FOREGOING, AND METHODS

(76) Inventor: Robert J. Nick, Pepperell, MA (US)

Correspondence Address: Martha Ann Finnegan;QD Vision, Inc., 4th Floor, 313 Pleasant Street, Watertown, MA, 02472, US

(21) Appl. No.: 12/727,941

(22) Filed: Mar. 19, 2010

Related U.S. Application Data
(60) Provisional application No. 61/161,728, filed on Mar. 19, 2009.
(60) Provisional application No. 61/162,223, filed on Mar. 20, 2009.
(60) Provisional application No. 61/262,773, filed on Nov. 19, 2009.

(51) Int. Cl. C09K 11/56; C09K 3/00; C09D 7/12

(52) U.S. Cl. 252/301.36; 252/301.6 S; 252/182.12; 252/182.11; 106/287.24; 106/287.26; 106/287.32

(57) ABSTRACT

One aspect of the present invention relates to a composition comprising a host material including quantum dots and one or more of the following additives: a UV absorbing dye; a humectant; an occlusant; a terpene; a surfactant; an antioxidant; a pigment; a fragrance; a fatty acid ester emulsifier; a fatty acid ester; a high molecular weight alcohol; an oxygen scavenger; a fatty alcohol; a silicone fluid; and a hydrocarbon oil. Other aspects of the present invention relate to a particle comprising a composition of the invention, a powder comprising a particle of the invention, a formulation including a composition of the invention, a coating including a composition of the invention, a taggant including a composition of the invention, a device including a composition of the invention, a method for making a composition of the invention, and other products and applications utilizing a composition of the invention. In a preferred embodiment, a quantum dot comprises a light-emissive semiconductor nanocrystal.

This application claims priority to U.S. Application Nos. 61/161,728, filed 19 Mar. 2009; 61/162,223, filed 20 Mar. 2009; and 61/262,773, filed 19 Nov. 2009. Each of the foregoing applications is hereby incorporated herein by reference in its entirety.

### TECHNICAL FIELD OF THE INVENTION

The present invention relates to the technical field of nanotechnology.

### SUMMARY OF THE INVENTION

More particularly, the present invention relates to a composition including quantum dots, uses of the foregoing, and methods.

In accordance with one aspect of the present invention, there is provided a composition comprising a host material including quantum dots and one or more of the following additives:

a terpene;

a fragrance;

a fatty acid ester emulsifier;

a fatty acid ester;

a high molecular weight alcohol;

an oxygen scavenger; and

a fatty alcohol.

In certain embodiments, an additive or combination of additives is included in an amount effective to improve the performance of at least one optical property of the quantum dots included in the composition.

In certain embodiments, one material can serve as one or more additives.

In certain embodiments an additive can comprise a mixture or combination of two or more materials.

In certain embodiments, a composition can comprise two or more of the additives.

In certain embodiments, a composition can comprise three or more of the additives.

In certain embodiments, a composition can comprise four or more of the additives.

In certain embodiments, a composition can comprise five or more of the additives

In certain embodiments, a composition can comprise six or more of the additives.

In certain embodiments, a composition in accordance with the invention includes one or more of the following additives: a fatty acid ester emulsifier; a fatty acid ester; a high molecular weight alcohol; an oxygen scavenger; and a fatty alcohol.

In certain embodiments, a composition in accordance with the invention includes two or more of the following additives: a fatty acid ester emulsifier; a fatty acid ester; a high molecular weight alcohol; an oxygen scavenger; and a fatty alcohol.

In certain embodiments, a composition in accordance with the invention includes three or more of the following additives: a fatty acid ester emulsifier; a fatty acid ester; a high molecular weight alcohol; an oxygen scavenger; and a fatty alcohol.

In certain embodiments, a composition in accordance with the invention includes four or more of the following additives: a fatty acid ester emulsifier; a fatty acid ester; a high molecular weight alcohol; an oxygen scavenger; and a fatty alcohol.

In certain embodiments, a composition in accordance with the invention includes the following additives: a fatty acid ester emulsifier; a fatty acid ester; a high molecular weight alcohol; an oxygen scavenger; and a fatty alcohol.

A composition in accordance with the invention can further comprise one or more of the following additional additives:

a UV absorbing dye;

a humectant;

an occlusant;

a surfactant;

an antioxidant;

a pigment; and

a viscosity modifier.

In certain embodiments, a composition can comprise two or more of the additional additives.

In certain embodiments, a composition can comprise three or more of the additional additives.

In certain embodiments, a composition can comprise four or more of the additional additives.

In certain embodiments, a composition can comprise five or more of the additional additives

In certain embodiments, a composition can comprise six or more of the additional additives.

In certain embodiments, a composition in accordance with the invention further includes one or more of: a UV absorbing dye; a humectant; a surfactant; and a viscosity modifier.

In certain embodiments, a composition in accordance with the invention further includes two or more of the following additional additives: a UV absorbing dye; a humectant; a surfactant; an antioxidant, and a viscosity modifier.

In certain embodiments, a composition in accordance with the invention further includes three or more of the following additional additives: a UV absorbing dye; a humectant; a surfactant; an antioxidant, and a viscosity modifier.

In certain embodiments, a composition in accordance with the invention further includes the following additional additives: a UV absorbing dye; a humectant; a surfactant; an antioxidant, and a viscosity modifier.

In certain embodiments, an additional additive or combination of additional additives is included in an amount effective to improve the performance of at least one optical property of the quantum dots included in the composition.

In certain embodiments, one material can serve as one or more additional additives.

In certain embodiments an additional additive can comprise a mixture or combination of two or more materials.

In certain embodiments, a host material can be optically transparent.

In certain embodiments, a host material can be optically transparent to excitation light used to optically excite the quantum dots.

In certain embodiments, a host material can be optically transparent to light emitted from quantum dots.

In certain embodiments, a host material can be optically transparent to both the excitation light and light emitted from quantum dots.

In certain embodiments, a host material can be optically translucent.

In certain embodiments, a host material is optically translucent to excitation light used to optically excite the quantum dots.

In certain embodiments, a host material can be optically translucent to light emitted from quantum dots.

In certain embodiments, a host material can be optically translucent to both the excitation light and light emitted from quantum dots.

In certain embodiments, a host material can comprise one or more host materials.

In certain embodiments, a host material comprises a solid.

In certain embodiments, a host material comprises a semi-solid. A semi-solid is generally recognized as a substance that is partly solid, having a rigidity and viscosity intermediate between a solid and a liquid. Examples include, but are not limited to semi-solid grease, semi-solid past, a gel, a foam, etc.

In certain embodiments, a solid can comprise a wax.

In certain embodiments, a host material can comprise two or more waxes.

In certain embodiments, a host material comprises a solid wax.

In certain embodiments, a host material comprises a semi-solid wax.

Examples of waxes include, without limitation, white wax, carnauba wax, and paraffin. Additional information relating to waxes that may be useful with the invention is included in U.S. Pat. No. 3,872,040, the disclosure of which is hereby incorporated herein by reference. Additional information and examples of waxes that may also be useful with the invention can be found at the website of the National Petrochemical & Refines Association under “Wax Facts” at http://www.npra.org/ourIndustry/waxFacts/, the disclosure of which is hereby incorporated herein by reference.

In certain embodiments, the wax is non-biodegradable.

In certain embodiments, a host material comprises a polymer.

In certain embodiments, a host material comprises a resin.

In certain embodiments, a host material comprises one or more polymers and/or resins.

Examples of polymers and resins include, for example and without limitation, polyacrylate, polymethacrylate polyethylene, polypropylene, polystyrene, polyethylene oxide, polysiloxane, polyphenylene, polythiophene, poly(phenylene-vinylene), polysilane, polyethylene terephthalate and poly(phenylene-ethynylene), polymethylmethacrylate, polycarbonate, epoxy, and other epoxies. Other polymers and resins can be readily ascertained by one of ordinary skill in the relevant art.

In certain embodiments, the composition can include at least about 0.001 weight percent quantum dots. In certain embodiments, the composition can include from about 0.001 to about 20 weight percent quantum dots. In certain embodiments, the composition can include from about 0.001 to about 10 weight percent quantum dots. In certain embodiments, the composition can include from about 0.001 to about 5 weight percent quantum dots. In certain embodiments, the composition can include from about 0.001 to about 2.5 weight percent quantum dots. In certain embodiments, the composition can include from about 0.001 to about 2.0 weight percent quantum dots. In certain embodiments, the composition can include from about 0.001 to about 1.0 weight percent quantum dots. In certain embodiments, the composition can include from about 0.01 to about 20 weight percent quantum dots. In certain embodiments, the composition can include from about 0.01 to about 10 weight percent quantum dots. In certain embodiments, the composition can include from about 0.01 to about 5 weight percent quantum dots. In certain embodiments, the composition can include from about 0.01 to about 3 weight percent quantum dots. In certain embodiments, the composition can include from about 0.01 to about 2 weight percent quantum dots. In certain embodiments, the composition can include from about 0.01 to about 1 weight percent quantum dots. In certain embodiments, the composition can include from about 0.1 to about 5 weight percent quantum dots. In certain embodiments, the composition can include from about 0.1 to about 3 weight percent quantum dots. In certain embodiments, the composition can include from about 0.1 to about 2 weight percent quantum dots. In certain embodiments, the composition can include from about 0.1 to about 1 weight percent quantum dots.

In certain embodiments the composition can include quantum dots in an amount selected to obtain a predetermined light emission intensity from the composition when excited to generate light emission.

In certain embodiments, quantum dots can have an average particle size in a range from about 1 to about 100 nm.

In certain embodiments, quantum dots can have an average particle size in a range from about 1 to about 30 nm.

In certain embodiments, quantum dots can have an average particle size in a range from about 1 to about 20 nm.

In certain embodiments, quantum dots can have an average particle size in a range from about 1 to about 15 nm.

In certain embodiments, quantum dots have an average particle size in a range from about 2 to about 10 nm.

In certain embodiments, quantum dots can have an average particle size in a range from about 2 to about 5 nm.

In certain embodiments, at least a portion of the quantum dots include a ligand attached to an outer surface of a quantum dot. In certain embodiments, two or more different ligand groups can be attached to an outer surface of at least a portion of the quantum dots.

In certain embodiments, one or more additives can be attached to an outer surface of a quantum dot as a coordinating ligand.

In certain embodiments, a population of quantum dots included in a composition can have a predetermined particle size distribution.

A composition in accordance with the invention can include quantum dots capable of emitting light having the same or substantially similar emission wavelength.

In certain embodiments, a composition includes quantum dots capable of emitting light at a predetermined wavelength.

A composition in accordance with the invention can include multiple quantum dot types, with at least two of the multiple quantum dot types being capable of emitting light with an emission wavelength that is distinct from at least each other. In certain embodiments, each of the different quantum dot types can be capable of emitting light with an emission wavelength that is distinct or different from that emitted by of each of the other types.

In certain embodiments in which one or more distinct predetermined emission wavelengths are desired, one or more chemically and/or physically distinct quantum dots can be included, wherein each of the chemically and/or physically distinct quantum dots has a composition, size, and/or structure selected to achieve the desired predetermined wavelength emission.

In certain embodiments, at least a portion of the quantum dots include a core comprising a first semiconductor material and a shell disposed over at least a portion of a surface of the core, the shell comprising a second semiconductor material.

In certain embodiments, a quantum dot can include two or more chemically distinct or different shells.

In certain embodiments, quantum dots comprise semiconductor nanocrystals.

In certain embodiments, at least a portion of the semiconductor nanocrystals include a core comprising a first semiconductor material and a shell disposed over at least a portion of a surface of the core, the shell comprising a second semiconductor material.

In certain embodiments, two or more chemically distinct shells can be included.

The size and composition of semiconductor nanocrystals and other quantum dots can be selected such that semiconductor nanocrystals or other quantum dots emit photons at a predetermined wavelength or wavelength hand in the far-visible, visible, infra-red or other desired portion of the spectrum. For example, the wavelength can be between 300 and 2,500 nm or greater, such as between 300 and 400 nm, between 400 and 700 nm, between 700 and 1100 nm, between 1100 and 2500 nm, or greater than 2500 nm.

Additional information concerning quantum dots and semiconductor nanocrystals is provided below.

A composition can include semiconductor nanocrystals that emit light at the same or different wavelengths. By including semiconductor nanocrystals that emit light at different wavelengths, multicolor emissions can be obtained.

In certain embodiments, a composition can comprise a host material, quantum dots, and two or more of the following additives: a terpene; an occlusant; an antioxidant; a fatty acid ester emulsifier; a fatty acid ester; a high molecular weight alcohol; an oxygen scavenger; and a fatty alcohol. In certain of such embodiments, the composition can further include a UV absorber, a humectant, a surfactant, a viscosity modifier, or a combination of any two or more of the foregoing.

In certain embodiments, any additive and/or other ingredient included in a composition in accordance with the invention can comprise a combination of two or more materials.

In one or more other embodiments, a composition can comprise a host material, quantum dots and two or more of the following additives: a fatty acid ester emulsifier; a fatty acid ester; a high molecular weight alcohol; an oxygen scavenger; and a fatty alcohol. In certain of such embodiments, the composition can further include a UV absorber, a humectant, a surfactant, a viscosity modifier, or a combination of any two or more of the foregoing.

In one or more embodiments, a composition can comprise a host material, quantum dots, a UV absorbing dye, a surfactant, a fatty acid ester, a fatty acid ester emulsifier, an oxygen scavenger, and a viscosity modifier.

In one or more embodiments, a composition can comprise a host material, quantum dots, a UV absorbing dye, a humectant, a surfactant, a fatty acid ester, a fatty acid emulsifier, an oxygen scavenger, and a viscosity modifier.

Preferably the quantum dots are uniformly or substantially uniformly distributed within the solid host material.

In certain embodiments of a composition in accordance with the invention, a UV absorbing dye can comprise, for example, Padimate O.

In certain embodiments of a composition in accordance with the invention, a humectant comprises, for example, arachidyl propionate.

In certain embodiments of a composition in accordance with the invention, an occlusant comprises, for example, arachidyl propionate.

In certain embodiments of a composition in accordance with the invention, a terpene can comprise, for example, camphor.

In certain embodiments of a composition in accordance with the invention, a surfactant can comprise, for example, cetyl alcohol, octyldodecanol, oleyl alcohol, etc.

In certain embodiments of a composition in accordance with the invention, an antioxidant can comprise, for example, a paraben, including, but not limited to, alkyl paraben (e.g., methyl paraben, propyl paraben, etc.)

In certain embodiments of a composition in accordance with the invention, a pigment can comprise, for example, titanium dioxide, D&C red no. 6 barium lake, FD&C yellow no. 5 aluminum lake, etc.

In certain embodiments of a composition in accordance with the invention, a fatty acid ester emulsifier can comprise, for example, isopropyl lanolate.

In certain embodiments of a composition in accordance with the invention, a fatty acid ester comprises, for example, lanolin, carnauba wax, isopropyl myristate, etc.;

In certain embodiments of a composition in accordance with the invention, a high molecular weight alcohol can comprise, for example, lanolin.

In certain embodiments of a composition in accordance with the invention, an oxygen scavenger can comprise, for example, titanium dioxide, a paraben, including, but not limited to, alkyl paraben (e.g., methyl paraben, propyl paraben, etc.).

In certain embodiments of a composition in accordance with the invention, a fatty alcohol can comprise, for example, octyldodecanol, oleyl alcohol, etc.

In certain embodiments of a composition in accordance with the invention, a viscosity modifier can comprise a silicone fluid (for example, but not limited to, phenyl trimethicone), a hydrocarbon oil (for example, but not limited to, white petrolatum, mineral oil, etc.), or other known viscosity modifying material.

In certain embodiments of a composition in accordance with the invention, a composition comprises quantum dots distributed in a ChapStick® formulation.

In certain embodiments of a composition in accordance with the invention, the ChapStick® formulation comprises ChapStick® Classic Original formulation.

In certain embodiments of a composition in accordance with the invention, quantum dots included in the composition can be included in one or more particles comprising quantum dots included in a second host material.

In certain embodiments, a particle comprising quantum dots included in a second host material has at least one dimension of at least about 5 nm.

In certain embodiments, for example, a particle can have a size in a range from about 5 nm to about 100 microns, from about 5 nm to about 50 microns, from about 5 nm to about 20 microns, from about 5 nm to about 10 microns, from about 10 nm to about 100 microns, from about 10 nm to about 50 microns, from about 10 nm to about 20 microns, from about 10 nm to about 10 microns, from about 0.1 micron to about 100 microns, from about 0.1 micron to about 50 microns, from about 0.1 micron to about 20 microns, from about 0.1 micron to about 10 microns, from about 0.5 micron to about 100 microns, from about 0.5 micron to about 50 microns, from about 0.5 micron to about 20 microns, from about 0.5 micron to about 10 microns, from about 1 micron to about 100 microns, from about 1 micron to about 50 microns, from about 1 micron to about 20 microns, from about 1 micron to about 10 microns, etc.

In certain embodiments, a particle comprising quantum dots included in a second host material includes at least about 0.001 weight percent quantum dots. In certain embodiments, a particle comprising quantum dots included in a second host material includes from about 0.001 to about 20 weight percent quantum dots. In certain embodiments, a particle comprising quantum dots included in a second host material includes from about 0.001 to about 10 weight percent quantum dots. In certain embodiments, a particle comprising quantum dots included in a second host material includes from about 0.001 to about 5 weight percent quantum dots. In certain embodiments, a particle comprising quantum dots included in a second host material includes from about 0.001 to about 2.5 weight percent quantum dots. In certain embodiments, a particle comprising quantum dots included in a second host material includes from about 0.001 to about 2.0 weight percent quantum dots. In certain embodiments, a particle comprising quantum dots included in a second host material includes from about 0.001 to about 1 weight percent quantum dots. In certain embodiments, a particle comprising quantum dots included in a second host material includes from about 0.01 to about 20 weight percent quantum dots. In certain embodiments, a particle comprising quantum dots included in a second host material includes from about 0.01 to about 10 weight percent quantum dots. In certain embodiments, a particle comprising quantum dots included in a second host material includes from about 0.01 to about 5 weight percent quantum dots. In certain embodiments, a particle comprising quantum dots included in a second host material includes from about 0.01 to about 3 weight percent quantum dots. In certain embodiments, a particle comprising quantum dots included in a second host material includes from about 0.01 to about 2 weight percent quantum dots. In certain embodiments, a particle comprising quantum dots included in a second host material includes from about 0.01 to about 1 weight percent quantum dots. In certain embodiments, a particle comprising quantum dots included in a second host material includes from about 0.1 to about 5 weight percent quantum dots. In certain embodiments, a particle comprising quantum dots included in a second host material includes from about 0.1 to about 3 weight percent quantum dots. In certain embodiments, a particle comprising quantum dots included in a second host material includes from about 0.1 to about 2 weight percent quantum dots. In certain embodiments, a particle comprising quantum dots included in a second host material includes from about 0.1 to about 1 weight percent quantum dots.

In certain embodiments, the second host material can be optically transparent.

In certain embodiments, the second host material can be optically transparent to excitation light used to optically excite the quantum dots.

In certain embodiments, the second host material can be optically transparent to light emitted from the light-emissive quantum dots.

In certain embodiments, the second host material can be optically transparent to both the excitation light and light emitted from the light-emissive quantum dots.

In certain embodiments, the second host material can be optically translucent.

In certain embodiments, the second host material can be optically translucent to excitation light used to optically excite the quantum dots.

In certain embodiments, the second host material can be optically translucent to light emitted from the light-emissive quantum dots.

In certain embodiments, the second host material can be optically translucent to both the excitation light and light emitted from the light-emissive quantum dots.

In certain embodiments, the second host material comprises a polymer.

In certain embodiments, the second host material comprises a monomer.

In certain embodiments, the second host material comprises a resin.

In certain embodiments, the second host material comprises one or more monomers, polymers, and/or resins.

Examples of polymers and resins include, for example and without limitation, polyethylene, polypropylene, polystyrene, polyethylene oxide, polysiloxane, polyphenylene, polythiophene, poly(phenylene-vinylene), polysilane, polyethylene terephthalate and poly(phenylene-ethynylene), polymethylmethacrylate, polycarbonate, epoxy, and other epoxies. Other polymers and resins can be readily ascertained by one of ordinary skill in the relevant art.

In certain preferred embodiments, the second host material comprises a polyacrylate. In certain embodiments, the second host material comprises a polymethacrylate.

Examples of monomers include, for example and without limitation, monomer precursors for the above listed polymer examples.

In certain embodiments, the second host material comprises an inorganic material, such as metal oxide (including, but not limited to, silica or titania).

In certain embodiments, the second host material can be a semi-solid.

In certain embodiments, the second host material comprises a solid wax.

In certain embodiments, the second host material comprises a semi-solid wax.

In certain embodiments, the second host material comprises a mixture of waxes.

In certain embodiments, the wax is non-biodegradable.

In certain embodiments, the second host material has the same composition as the host material.

In certain embodiments, a particle can further include one or more other components. In certain embodiments, the one or more other components can include a pigment or colorant, a scatterer, a binder, a surfactant, a UV absorber, and/or a mixture of one or more thereof. Any of the additives or additional additives described herein can also be included in a particle.

In certain embodiments, components can be selected based on the intended end-use application. Such selection of additives and/or other components can be readily ascertained by one of ordinary skill in the relevant art.

In certain embodiments, a population of particles comprising quantum dots in a second host material has a predetermined particle size distribution.

A predetermined particles size distribution can be achieve by screening or by other techniques readily ascertainable by one of ordinary skill in the relevant art.

In certain embodiments, a composition can comprise two or more populations of particles, wherein at least one population of particles includes quantum dots that can emit light at a wavelength that is distinct from that emitted by quantum dots included in at least one of the other populations of particles. In certain embodiments, each population of particles includes quantum dots that can emit light at a wavelength that is distinct from that emitted by each of the other populations of quantum dots included in a composition.

In accordance with another aspect of the present invention there is provided a particle comprising a composition of the invention.

In certain embodiments, a particle can comprise two or more compositions taught herein, which can be the same or different.

In certain embodiments, a particle can have a size of at least about 5 nm. In certain embodiments, for example, a particle can have a size in a range from about 5 nm to about 100 microns, from about 5 nm to about 50 microns, from about 5 nm to about 20 microns, from about 5 nm to about 10 microns, from about 10 nm to about 100 microns, from about 10 nm to about 50 microns, from about 10 nm to about 20 microns, from about 10 nm to about 10 microns, from about 0.1 micron to about 100 microns, from about 0.1 micron to about 50 microns, from about 0.1 micron to about 20 microns, from about 0.1 micron to about 10 microns, from about 0.5 micron to about 100 microns, from about 0.5 micron to about 50 microns, from about 0.5 micron to about 20 microns, from about 0.5 micron to about 10 microns, from about 1 micron to about 100 microns, from about 1 micron to about 50 microns, from about 1 micron to about 20 microns, from about 1 micron to about 10 microns, etc.

In accordance with another aspect of the present invention, there is provided a powder comprising a plurality of particles in accordance with the present invention.

In certain embodiments, a powder can comprise two or more populations of particles wherein each population comprises particles including one or more compositions taught herein, wherein the one or more compositions included in the particles of each population of particles can be the same as or different from that of another population.

In certain embodiments, a powder can comprise a combination of two or more populations of particles, wherein at least two of the populations of particles are capable of emitting light having an emission wavelength that is distinct from each other.

In certain embodiments, a powder can comprise a combination of two or mare populations of particles, wherein each of the two or more populations of particles are capable of emitting light having an emission wavelength that is distinct from each other.

In accordance with a further aspect of the present invention, there is provided a formulation comprising a composition of the invention and a solid or liquid medium.

Selection of a solid and/or liquid medium for use in a formulation can be readily made by one of ordinary skill in the art based on the intended use or application.

In certain embodiments, the liquid medium can be a polar or non-polar.

In certain embodiments, the liquid medium can comprise an aqueous solvent.

In certain embodiments, the liquid medium comprises a non-aqueous or organic solvent.

In certain embodiments, volatile liquids or mixtures of volatile liquids can be used.

In certain embodiments, a solid medium can comprise a polymer.

In certain embodiments, a solid medium can comprise a resin.

Examples of other solid media also include, without limitation, any of the host materials and second host materials described herein.

Examples of other liquid media also include, without limitation, any other liquid media described herein.

In certain embodiments, a formulation can comprise a two or more compositions taught herein, which can be the same or different.

In certain embodiments, a composition can be included in the formulation in the form of a powder taught herein.

In certain embodiments, a formulation can further include one or more other components. In certain embodiments, the one or more other components can include a pigment or colorant, a scatterer, a binder, a surfactant, a UV absorber, and/or a mixture of one or more thereof. Any of the additives or additional additives described herein can also be included in a formulation.

In certain embodiments, components can be selected based on the intended end-use application. Such selection of additives and/or other components can be readily ascertained by one of ordinary skill in the relevant art.

In accordance with a further aspect of the present invention, there is provided a coating comprising a composition of the invention.

In certain embodiments, a coating can comprise a two or more compositions taught herein, which can be the same or different.

In certain embodiments, a composition can be included in the coating in the form of a powder taught herein.

In accordance with a further aspect of the present invention, there is provided a taggant comprising a composition of the invention.

For example, in certain embodiments, a taggant can include a composition in accordance with the invention that includes one or more types of quantum dots, each of which can be capable of emitting light having a predetermined emission wavelength. In certain embodiments, multiple types of quantum dots with differing emission wavelengths can be included in the composition to provide coding capability for generating a predetermined code. The intensity of the quantum dot emission can depend on the number of quantum dots. Examining the spectral intensity and wavelength of the peaks can generate unique codes. Filters (e.g., bandpass filters) can be used in viewing the quantum dot emission to discriminate between different quantum dot emission wavelengths. By varying the types of quantum dot constituents and varying the concentration thereof in the composition, different codes can be generated.

In certain embodiments, a taggant can comprise two or more compositions taught herein, which can be the same or different.

In certain embodiments, a composition can be included in the taggant in the form of a powder taught herein.

In accordance with a further aspect of the present invention, there is provided a device comprising a composition of the invention.

In accordance with yet another aspect of the present invention, there is provided a method for preparing a composition of the invention. The method comprises melting a host material comprising a wax and mixing quantum dots and one or more of the above-listed additives therewith.

In certain embodiments, the method comprises melting a ChapStick® formulation and mixing quantum dots therewith.

In certain embodiments, the method is carried out at a temperature that is not detrimental to the quantum dots or any ligand group(s) that may be attached thereto.

In certain embodiments, the quantum dots are added as a dispersion of quantum dots in a volatilizable liquid. In such embodiments, the method further includes removing the volatilizable liquid. In certain embodiments, the volatilizable liquid is removed by heating or reducing the pressure of the admixture

Examples of volatilizable liquids include, without limitation, hexane, toluene, and other organic solvents. Additional examples of volatilizable liquids can be readily identified by one of ordinary skill in art.

In certain embodiments, the method is carried out under reduced pressure (e.g., 1 to 1000 mtorr).

In certain embodiments, quantum dots are added to the melted host material comprising a wax in the form of particles comprising quantum dots in a second host material.

Examples provided in the present disclosure are non-limiting and are provided for illustrative purposes only.

The foregoing, and other aspects and embodiments described herein and contemplated by this disclosure all constitute embodiments of the present invention.

It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

It is to be understood that both the foregoing general description and the following detailed description are exemplary and explanatory only and are not restrictive of the invention as claimed. Other embodiments will be apparent to those skilled in the art from consideration of the specification and practice of the invention disclosed herein.

### BRIEF DESCRIPTION OF THE DRAWINGS

In the drawings,

FIG. 1 depicts spectra to illustrate a method for measuring quantum efficiency.

For a better understanding to the present invention, together with other advantages and capabilities thereof, reference is made to the following disclosure and appended claims in connection with the above-described drawings.

### DESCRIPTION OF THE INVENTION

In accordance with one aspect of the present invention, provided a composition comprising a host material including quantum dots and one or more of the following additives:

a terpene;

a fragrance;

a fatty acid ester emulsifier;

a fatty acid ester;

a high molecular weight alcohol;

an oxygen scavenger; and

a fatty alcohol.

In certain embodiments, an additive or combination of additives is included in an amount effective to improve the performance of at least one optical property of the quantum dots included in the composition.

In certain embodiments, an additive can be included in the composition in an amount of at least about 0.001 weight percent, based on the total weight of the composition.

In certain embodiments, an additive can be included in the composition in an amount of at least about 0.01 weight percent, based on the total weight of the composition.

In certain embodiments, an additive can be included in the composition in an amount of at least about 0.1 weight percent, based on the total weight of the composition.

In certain embodiments, an additive can be included in the composition in an amount in a range from about 0.001 to about 10 weight percent, based on the total weight of the composition, e.g., from about 0.001 to about 5 weight percent, from about 0.001 to about 3 weight percent, from about 0.001 to about 2 weight percent, from about 0.001 to about 1 weight percent.

In certain embodiments, an additive can be included in the composition in an amount in a range from about 0.01 to about 10 weight percent, based on the total weight of the composition, e.g., from about 0.01 to about 5 weight percent, from about 0.01 to about 3 weight percent, from about 0.01 to about 2 weight percent, from about 0.01 to about 1 weight percent.

In certain embodiments, an additive can be included in the composition in an amount in a range from about 0.1 to about 10 weight percent, based on the total weight of the composition, e.g., from about 0.1 to about 5 weight percent, from about 0.1 to about 3 weight percent, from about 0.1 to about 2 weight percent, from about 0.1 to about 1 weight percent.

In certain embodiments, one material can serve as one or more additive.

In certain embodiments an additive can comprise two or more materials.

In certain embodiments, a composition can comprise two or more of the additives.

In certain embodiments, a composition can comprise three or more of the additives.

In certain embodiments, a composition can comprise four or more of the additives.

In certain embodiments, a composition can comprise five or more of the additives

In certain embodiments, a composition can comprise six or more of the additives.

In certain embodiments, a composition in accordance with the invention includes one or more of the following additives: a fatty acid ester emulsifier; a fatty acid ester; a high molecular weight alcohol; an oxygen scavenger; and a fatty alcohol.

In certain embodiments, a composition in accordance with the invention includes two or more of the following additives: a fatty acid ester emulsifier; a fatty acid ester; a high molecular weight alcohol; an oxygen scavenger; and a fatty alcohol.

In certain embodiments, a composition in accordance with the invention includes three or more of the following additives: a fatty acid ester emulsifier; a fatty acid ester; a high molecular weight alcohol; an oxygen scavenger; and a fatty alcohol.

In certain embodiments, a composition in accordance with the invention includes four or more of the following additives: a fatty acid ester emulsifier; a fatty acid ester; a high molecular weight alcohol; an oxygen scavenger; and a fatty alcohol.

In certain embodiments, a composition in accordance with the invention includes the following additives: a fatty acid ester emulsifier; a fatty acid ester; a high molecular weight alcohol; an oxygen scavenger; and a fatty alcohol.

A composition in accordance with the invention can further comprise one or more of the following additional additives:

a UV absorbing dye;

a humectant;

an occlusant;

a surfactant;

an antioxidant;

a pigment; and

a viscosity modifier.

In certain embodiments, a composition can comprise two or more of the additional additives.

In certain embodiments, a composition can comprise three or more of the additional additives.

In certain embodiments, a composition can comprise four or more of the additional additives.

In certain embodiments, a composition can comprise five or more of the additional additives

In certain embodiments, a composition can comprise six or more of the additional additives.

In certain embodiments, a composition in accordance with the invention further includes one or more of the following additional additives: a UV absorbing dye; a humectant; a surfactant; and a viscosity modifier.

In certain embodiments, a composition in accordance with the invention further includes two or more of the following additional additives: a UV absorbing dye; a humectant; a surfactant; and a viscosity modifier.

In certain embodiments, a composition in accordance with the invention further includes three or more of the following additional additives: a UV absorbing dye; a humectant; a surfactant; and a viscosity modifier.

In certain embodiments, a composition in accordance with the invention further includes the following additional additives: a UV absorbing dye; a humectant; a surfactant; and a viscosity modifier.

In certain embodiments, an additional additive or combination of additional additives is included in an amount effective to improve the performance of at least one optical property of the quantum dots included in the composition.

In certain embodiments, an additional additive can be included in the composition in an amount of at least about 0.001 weight percent, based on the total weight of the composition.

In certain embodiments, an additional additive can be included in the composition in an amount of at least about 0.01 weight percent, based on the total weight of the composition.

In certain embodiments, an additional additive can be included in the composition in an amount of at least about 0.1 weight percent, based on the total weight of the composition.

In certain embodiments, an additional additive can be included in the composition in an amount in a range from about 0.001 to about 10 weight percent, based on the total weight of the composition, e.g., from about 0.001 to about 5 weight percent, from about 0.001 to about 3 weight percent, from about 0.001 to about 2 weight percent, from about 0.001 to about 1 weight percent.

In certain embodiments, an additional additive can be included in the composition in an amount in a range from about 0.01 to about 10 weight percent, based on the total weight of the composition, e.g., from about 0.01 to about 5 weight percent, from about 0.01 to about 3 weight percent, from about 0.01 to about 2 weight percent, from about 0.01 to about 1 weight percent.

In certain embodiments, an additional additive can be included in the composition in an amount in a range from about 0.1 to about 10 weight percent, based on the total weight of the composition, e.g., from about 0.1 to about 5 weight percent, from about 0.1 to about 3 weight percent, from about 0.1 to about 2 weight percent, from about 0.1 to about 1 weight percent.

In certain embodiments, one material can serve as one or more additional additives.

In certain embodiments an additional additive can comprise two or more materials.

In certain embodiments, one material can serve as two or more of any of the additives.

In certain embodiments, an additive or combination of additives is included in an amount effective to improve the performance of at least one optical property of the quantum dots in the composition.

A UV absorbing dye additive can comprise an ultraviolet absorbing compound which can organic or inorganic. Examples of ultraviolet absorbing compounds include, for example, but are not limited to, aminobenzoic acid, avobenzone, cinoxate, dioxybenzone, homosalate, menthyl anthranilate, octocrylene, octyl methoxycinnamate, octyl salicylate, oxybenzone, Padimate O, phenylbenzimidazole sulfonic acid, sulisobenzone trolamine salicylate, hydroxyphenyltriazenes, benzotriazoles, benzophenone, and oxyanilides. Additional examples of ultraviolet absorbing compounds may be found, e.g., in U.S. Pat. No. 7,316,809 & U.S. Publication No. 20090311336. Other UV absorbing dyes or compounds for use as a UV absorbing dye additive can be readily identified by the skilled artisan. Preferably each UV absorbing dye additive is compatible with (e.g., not reactive with) other ingredients in the composition. A UV absorbing dye can comprise a single UV absorbing dye or a mixture of two more UV absorbing dyes.

A humectant additive can comprise, for example, but is not limited to, polyhydric alcohols. Examples humectants additional include, but are not limited to, glycerin, ethylene glycol, diethylene glycol, triethylene glycol, propylene glycol, dipropylene glycol, tripropylene glycol, 1,3-butane diol, 2,3-butane diol, 1,4-butane diol, 3-methyl-1,3-butane diol, 1,5-pentane diol, tetraethylene glycol, 1,6-hexane diol, 2-methyl-2,4-pentane dial, polyethylene glycol, 1,2,4-butanetriol, 1,2,6-hexanetriol and the like. Other humectants for use as a humectant additive can be readily identified by the skilled artisan. Preferably each humectant additive is compatible with (e.g., not reactive with) other ingredients in the composition. A humectant additive can comprise a single humectant or a mixture of two or more humectants.

An occlusant additive can comprise, for example, but is not limited to, a vegetable fat, such as, for example, but not limited to, cocoa butter, and/or an animal fat, such as, for example, but not limited to, lanolin. Other occlusants for use as an occlusant additive can be readily identified by the skilled artisan. Preferably each occlusant additive is compatible with (e.g., not reactive with) other ingredients in the composition. An occlusant additive can comprise a single occlusant or a mixture of two or more occlusants.

A terpene is a member of a class of molecules that typically contain either 10 or 15 carbon atoms built from a five carbon building block called isoprene. See the Chemistry Encyclopedia (http://www.chemistryexplained.com/Te-Va/Terpenes.html). A terpene additive may comprise, for example, but is not limited to, compounds such as camphor, menthol, pinene, β-carotene. Additional examples of terpenes may be found, e.g., in U.S. Publication No. 20090036554. Other terpenes for use as a terpene additive can be readily identified by the skilled artisan. A terpene additive can comprise a single terpene or a mixture of two or more terpenes.

A surfactant additive may comprise, for example, but is not limited to, a anhydrous ionic surfactant, including, for example, but not limited to, phosphate esters, sulfates, carboxylates, fatty amine salts, quaternary nitrogen salts, mineral, vegetable and animal derived oils and fats. A surfactant additive may further comprise a nonionic surfactant, including for example, but not limited to, cetyl alcohol, octyldodecanol, oleyl alcohol, etc. A surfactant additive may comprise an amphoteric surfactant. Examples of an amphoteric surfactant include for example, but are not limited to, an amino acid-type amphoteric surfactant, a betaine-type amphoteric surfactant, a sulfate-type amphoteric surfactant, a sulfonate-type amphoteric surfactant, and a phosphate-type amphoteric surfactant. Other surfactants for use as a surfactant additive can be readily identified by the skilled artisan. A surfactant additive can comprise a single surfactant or a mixture of two or more surfactants. Other types or classes of surfactants can also be used.

An antioxidant additive can comprise, for example, but is not limited to, a molecule that acts to slow or prevent oxidation of other molecules, such as, for example, a paraben, including, but not limited to, alkyl paraben (e.g., methyl paraben, propyl paraben, etc.), a hindered amine light stabilizer such as (Bis(1-octyloxy-2,2,6,6-tetramethyl-4-piperidyl)sebacate), hydroquinone or benzofuranones. Other antioxidants for use as an antioxidant additive can be readily identified by the skilled artisan. An antioxidant additive can comprise a single antioxidant or a mixture of two or more antioxidants.

A pigment additive can comprise, for example, but is not limited to, a natural pigment (e.g., titanium dioxide, zinc oxide, etc (which can also act as sunscreens (e.g., UVA and/or UVB blockers.)) or a synthetic pigment or colorant (e.g., Red-6 Ca, Red-6 sodium, red iron oxide, Red 21, and Red 27. D&C red no. 6 barium lake, FD&C yellow no. 5, aluminum lake, etc.). Other pigments or colorants for use as a pigment additive can be readily identified by the skilled artisan. A pigment additive can comprise a single pigment or a mixture of two or more pigments.

A fragrance additive can comprise, for example, but is not limited to, a natural or synthetic scent or flavor compound. Examples of natural and/or synthetic scent or flavor compound for use as a fragrance additive can be readily identified by the skilled artisan. A fragrance additive can comprise a single scent or flavor compound or a mixture of two or more scent and/or flavor compounds.

A fatty acid ester emulsifier (e.g., a material that can emulsify a fatty acid ester) additive can comprise, for example, but is not limited to, isopropyl lanolate. Other fatty acid ester emulsifiers for use as a fatty acid ester emulsifier additive can be readily identified by the skilled artisan. A fatty acid ester emulsifier additive can comprise a single fatty acid ester emulsifier or a mixture of two or more fatty acid ester emulsifiers.

A fatty acid ester additive can comprise, for example, but is not limited to, an ester such as, for example, lanolin, carnauba wax, isopropyl myristate, etc. Other examples include esterified monobasic acids, especially those found in animal and vegetable fats and oils, having the general formula CₙH₂ₙ+₁COOH, which typically are made up of saturated or unsaturated aliphatic compounds with an even number of carbon atoms, this group of acids includes, for example, but not limited to, palmitic, stearic, and oleic acids. Other fatty acid esters for use as a fatty acid ester additive can be readily identified by the skilled artisan. A fatty acid ester additive can comprise a single fatty acid ester or a mixture of two or more fatty acid esters.

A high molecular weight alcohol additive can comprise; for example, but not limited to, lanolin, cetyl alcohol, stearyl alcohol, etc. Other high molecular weight alcohols for use as a high molecular weight alcohol additive can be readily identified by the skilled artisan. High molecular weight alcohols are typically not soluble in water. A high molecular weight alcohol additive can comprise a single high molecular weight alcohol or a mixture of two or more high molecular weight alcohol.

An oxygen scavenger additive can comprise, for example, but not limited to, such as, for example, titanium dioxide, a paraben, including, but not limited to, alkyl paraben (e.g., methyl paraben, propyl paraben, etc. Other oxygen scavengers for use as a oxygen scavenger additive can be readily identified by the skilled artisan. A oxygen scavenger additive can comprise a single oxygen scavenger or a mixture of two or more oxygen scavenger.

A fatty alcohol additive can comprise, for example, but not limited to, ocytldodecanol, oleyl alcohol; etc. Examples of other fatty alcohols include alcohol versions of fatty acids. Other fatty alcohols for use as a fatty alcohol additive can be readily identified by the skilled artisan. A fatty alcohol additive can comprise a single fatty alcohol or a mixture of two or more fatty alcohol.

In certain embodiments, a viscosity modifier can comprise a silicone fluid, a hydrocarbon oil, or other known viscosity modifying material.

In certain embodiments, the amount of viscosity modifier included in a composition is selected based on the molecular weight of the particular host material and the desired viscosity based on the intended end-use application of the composition. Such amount can be determined by the skilled artisan by routine techniques.

A silicone fluid additive can comprise, for example, but not limited to, phenyl trimethicone, etc. Other silicone fluids for use as a silicone fluid additive can be readily identified by the skilled artisan. A silicone fluid additive can comprise a single silicone fluid or a mixture of two or more silicone fluids.

A hydrocarbon oil additive can comprise, for example, but not limited to, white petrolatum, mineral oil. Other hydrocarbon oils for use as a hydrocarbon oil additive can be readily identified by the skilled artisan. A hydrocarbon oil additive can comprise a single hydrocarbon oil or a mixture of two or more hydrocarbon oils.

Other viscosity modifying materials for use as a silicone fluid additive can be readily identified by the skilled artisan.

In certain embodiments, the host material comprises a solid.

In certain embodiments, the host material comprises semi-solid form.

In certain embodiments, the host material can be optically transparent.

In certain embodiments, the host material can be optically translucent.

In certain embodiments, the host material comprises a wax or a mixture of two or more waxes.

Examples of waxes include, without limitation, white wax, carnauba wax, and paraffin.

Additional information relating to waxes that may be useful with the present invention is included in U.S. Pat. No. 3,872,040, the disclosure of which is hereby incorporated herein by reference. Additional examples of waxes include, without limitation, petrolatum wax; white wax; candelilla wax; beeswax; oils, such as arachidyl propionate, cetyl alcohol, isopropyl lanolate, isopropyl myristate, lanolin, mineral oil, light mineral oil, octyldodecanol, oleyl alcohol, ethyl macadamiate, castor oil, jojoba esters, hydrogenated castor oil, hydrogenated vegetable oil, cetyl ricinoleate, propylene glycol, isopropyl palmitate, stearyl alcohol, and volatile and non-volatile silicone oils; and any combination of any of the foregoing. Suitable silicone oils include, but are not limited to, polyphenylmethyl siloxane, dimethicone, cyclomethicone, and any combination of any of the foregoing.

Additional information and examples of waxes that may also be useful with the invention can be found at the website of the National Petrochemical & Refines Association under “Wax Facts” at http://www.npra.org/ourIndustry/waxFacts/, the disclosure of which is hereby incorporated herein by reference.

In certain embodiments, the wax is non-biodegradable.

In certain embodiments, a composition comprises quantum dots distributed in a ChapStick® formulation.

ChapStick® is a product line of Wyeth Consumer Healthcare. The most current labeling information for ChapStick® formulations, which may differ from labels on product packaging, is available at http://www.chapstick.com/home.asp, which is hereby incorporated herein by reference in its entirety.

In one embodiment, the Chap Stick formulation comprises ChapStick® Classic Original. The labeling information for listed at http://www.chapstick.com/classic/regular_label.aspon.

As of Feb. 23, 2009, the listed ingredients for CHAPSTICK® Classic Original include: Padimate O (1.5%); White petrolatum (44%); arachidyl propionate, camphor, carnauba wax, cetyl alcohol, D&C red no. 6 barium lake, FD&C yellow no. 5 aluminum lake, fragrance, isopropyl lanolate, isopropyl myristate, lanolin, light mineral oil, methylparaben, octyldodecanol, oleyl alcohol, paraffin, phenyl trimethicone, propylparaben, titanium dioxide, and white wax.

Additional information Concerning other materials and processes that may be useful with the invention is found in U.S. Pat. No. 7,073,965 of Look et al, issued 11 Jul. 2006 for “Multi composition stick product and a process and system for manufacturing same”, the disclosure of which is hereby incorporated herein by reference in its entirety.

Examples of other solids include, but are not limited to, polymers and resins described elsewhere herein. Examples of semi-solids include, but are not limited to, semi-solid waxes, semi-solid greases, semi-solid pastes, gels, foams, etc.

In certain embodiments, the quantum dots included in a composition are capable of emitting light at a predetermined wavelength.

In certain embodiments, it is desirable to have quantum dot emissions at two or more distinct predetermined wavelengths. In such case two or more chemically and/or physically distinct quantum dots are included, wherein each of the distinct quantum dots has a composition, size, and/or structure selected to achieve the desired predetermined wavelength emission.

In certain embodiments, quantum dots comprise semiconductor nanocrystals.

In certain embodiments, at least a portion of the quantum dots include a core comprising a first semiconductor material and a shell disposed over at least a portion of an outer surface of the core, the shell comprising a second semiconductor material. Quantum dots are discussed further below.

In certain embodiments, quantum dots can include one or more ligands attached to an outer surface thereof.

In certain embodiments, one or more additives can be attached to an outer surface of a quantum dot as a coordinating ligand.

The concentration of quantum dots in the host material can be varied.

In certain embodiments, the composition can include at least about 0.001 weight percent quantum dots. In certain embodiments, the composition can include from about 0.001 to about 20 weight percent quantum dots. In certain embodiments, the composition can include from about 0.001 to about 10 weight percent quantum dots. In certain embodiments, the composition can include from about 0.001 to about 5 weight percent quantum dots. In certain embodiments, the composition can include from about 0.001 to about 2.5 weight percent quantum dots. In certain embodiments, the composition can include from about 0.001 to about 2.0 weight percent quantum dots. In certain embodiments, the composition can include from about 0.001 to about 1.0 weight percent quantum dots. In certain embodiments, the composition can include from about 0.01 to about 20 weight percent quantum dots. In certain embodiments, the composition can include from about 0.01 to about 10 weight percent quantum dots. In certain embodiments, the composition can include from about 0.01 to about 5 weight percent quantum dots. In certain embodiments, the composition can include from about 0.01 to about 3 weight percent quantum dots. In certain embodiments, the composition can include from about 0.01 to about 2 weight percent quantum dots. In certain embodiments, the composition can include from about 0.01 to about 1 weight percent quantum dots. In certain embodiments, the composition can include from about 0.1 to about 5 weight percent quantum dots. In certain embodiments, the composition can include from about 0.1 to about 3 weight percent quantum dots. In certain embodiments, the composition can include from about 0.1 to about 2 weight percent quantum dots. In certain embodiments, the composition can include from about 0.1 to about 1 weight percent quantum dots.

In certain embodiments the composition can include quantum dots in an amount selected to obtain a predetermined light emission intensity from the composition when excited to generate light emission.

These weights are on an inorganics basis as determined by thermogravimetric analysis of the quantum dot solutions.

(The weight percent of the quantum dots is determined based on the weight of the quantum dot without regard to any ligand(s) that may be attached thereto.)

In certain embodiments the composition can include quantum dots in an amount selected to obtain a predetermined light emission intensity from the composition when excited to generate light emission.

In certain embodiments, the quantum dots are distributed in the host material. In certain embodiments, the quantum dots are substantially uniformly distributed throughout the host material.

In certain embodiments, a composition can comprise a host material, quantum dots, and two or more of the following additives; a terpene; an occlusant; an antioxidant; a fatty acid ester emulsifier; a fatty acid ester; a high molecular weight alcohol; an oxygen scavenger; and a fatty alcohol. In certain of such embodiments, the composition further includes a UV absorber, a humectant, and/or a surfactant.

As mentioned above, any additive or other ingredient can comprise two or more materials.

In certain embodiments, for example, a composition can comprise a host material, quantum dots and two or more of the following additives: a fatty acid ester emulsifier; a fatty acid ester; a high molecular weight alcohol; an oxygen scavenger; and a fatty alcohol. In certain of such embodiments, the composition can further comprise an antioxidant, a UV absorber, a dye, and/or a pigment.

In certain embodiments, the quantum dots are uniformly or substantially uniformly distributed within the host material.

As mentioned above, any additive or other ingredient can comprise two or more materials.

In certain embodiments, at least a portion of the quantum dots are included in the composition in the form of particles comprising quantum dots included in a second host material.

In certain embodiments, a particle comprising quantum dots included in a second host material has at least one dimension of at least 5 nm.

In certain embodiments, for example, a particle can have a size in a range from about 5 nm to about 100 microns, from about 5 nm to about 50 microns, from about 5 nm to about 20 microns, from about 5 nm to about 10 microns, from about 10 nm to about 100 microns, from about 10 nm to about 50 microns, from about 10 nm to about 20 microns, from about 10 nm to about 10 microns, from about 0.1 micron to about 100 microns, from about 0.1 micron to about 50 microns, from about 0.1 micron to about 20 microns, from about 0.1 micron to about 10 microns, from about 0.5 micron to about 100 microns, from about 0.5 micron to about 50 microns, from about 0.5 micron to about 20 microns, from about 0.5 micron to about 10 microns, from about 1 micron to about 100 microns, from about 1 micron to about 50 microns, from about 1 micron to about 20 microns, from about 1 micron to about 10 microns, etc.

In certain embodiments, a particle comprising quantum dots included in a second host material includes at least about 0.001 weight percent quantum dots. In certain embodiments, a particle comprising quantum dots included in a second host material includes from about 0.001 to about 5 weight percent quantum dots. In certain embodiments, a particle comprising quantum dots included in a second host material includes from about 0.001 to about 2.5 weight percent quantum dots. In certain embodiments, a particle comprising quantum dots included in a second host material includes from about 0.01 to about 2 weight percent quantum dots.

In certain embodiments, the second host material comprises a polymer.

In certain embodiments, the second host material comprises one or more monomers, polymers, and/or resins.

Particles comprising quantum dots and a second host material can be prepared through use of techniques that can be readily identified by one of ordinary skill in the relevant art.

Examples of polymers and resins include, for example and without limitation, polyacrylate, polymethacrylate, polyethylene, polypropylene, polystyrene, polyethylene oxide, polysiloxane, polyphenylene, polythiophene, poly(phenylene-vinylene), polysilane, polyethylene terephthalate and poly(phenylene-ethynylene), polymethylmethacrylate, polycarbonate, epoxy, and other epoxies. Other polymers and resins can be readily ascertained by one of ordinary skill in the relevant art.

Particles including a second host material comprising a polymer can be prepared by photo-emulsion polymerization.

Examples of monomers include, for example and without limitation, monomer precursors for the above listed polymer examples.

In certain embodiments, the second host material comprises a mixture of including one or more monomers, polymers, and/or resins.

In certain embodiments, the second host material comprises an inorganic material, such as metal oxide (including, but not limited to, silica or titania).

In certain embodiments, the second host material comprises a solid wax. In certain embodiments, the second host material comprises a semi-solid wax. In certain embodiments, the second host material comprises a mixture of waxes. In certain embodiments, the wax is non-biodegradable.

In certain embodiments, the second host material is optically transparent. In certain embodiments, the second host material is optically transparent to excitation light used to optically excite the quantum dots. In certain embodiments, the second host material is optically transparent to light emitted from the light-emissive quantum dots. In certain embodiments, the second host material is optically transparent to both the excitation light and light emitted from the light-emissive quantum dots.

In certain embodiments, the second host material has the same composition as the host material. In certain embodiments, a particle can include one or more additives. In certain embodiments, the one or more additives can include a colorant, a scatterer, a binder, a surfactant, a UV absorber, and/or a mixture of one or more thereof.

In certain embodiments, the additives are selected based on the intended end-use application. Such additives can be readily ascertained by one of ordinary skill in the relevant art.

In certain embodiments, a population of particles comprising quantum dots in a second host material has a predetermined particle size distribution.

In certain embodiments, a population of particles can be monomodal.

In certain embodiments, a population of particles can be multimodal.

A predetermined particles size distribution can be achieve by screening or by other techniques readily ascertainable by one of ordinary skill in the relevant art.

In certain embodiments, particles in accordance with aspects and/or embodiments of the present invention can be prepared by various techniques that include, but are not limited to, milling, jet milling, ball milling, media milling, micronizing, micro-fluidizing, spray-drying, emulsion polymerization, etc. Other techniques can be ascertained by a person of ordinary skill in the art.

In certain embodiments, the composition comprises two or more populations of particles, wherein at least one population of particles includes quantum that emit light at a wavelength that is distinct from that emitted by quantum dots included in another population of particles.

In another aspect of the present invention, there is provided a particle comprising a composition in accordance with the present invention.

In certain embodiments, a particle can have a size of at least about 5 nm. In certain embodiments, for example, a particle can have a size in a range from about 5 nm to about 100 microns, from about 5 nm to about 50 microns, from about 5 nm to about 20 microns, from about 5 nm to about 10 microns, from about 10 nm to about 100 microns, from about 10 nm to about 50 microns, from about 10 nm to about 20 microns, from about 10 nm to about 10 microns, from about 0.1 micron to about 100 microns, from about 0.1 micron to about 50 microns, from about 0.1 micron to about 20 microns, from about 0.1 micron to about 10 microns, from about 0.5 micron to about 100 microns, from about 0.5 micron to about 50 microns, from about 0.5 micron to about 20 microns, from about 0.5 micron to about 10 microns, from about 1 micron to about 100 microns, from about 1 micron to about 50 microns, from about 1 micron to about 20 microns, from about 1 micron to about 10 microns, etc.

In certain embodiments, the particle can have a size in a range from about 0.01 to about 5 microns.

In certain embodiments, the particle can have a size in a range from about 1 to about 30 microns.

In certain embodiments, the particle can have a size in a range from about 1 to about 20 microns.

Particles in accordance with certain embodiments of the invention that are micron sized can facilitate inclusion of quantum dots in formulations, other compositions, processes, and applications, while avoiding the handling of nano-sized materials.

In certain embodiments, particles in accordance with aspects and/or embodiments of the present invention can be prepared by various techniques that include, but are not limited to, milling, jet milling, ball milling, media milling, micronizing, micro-fluidizing, spray-drying, emulsion polymerization, etc. Other techniques can be ascertained by a person of ordinary skill in the art.

In certain embodiments, particles including a host material comprising a polymer can be prepared by photo-emulsion polymerization. Other polymerization techniques can also be used.

In accordance with another aspect of the invention, there is provided a powder comprising a plurality of particles in accordance with the present invention.

In certain embodiments, a powder can comprise a two or more populations of particles wherein each population comprises particles including one or more compositions taught herein, wherein the one or more compositions included in the particles of each population of particles included in the powder can be the same as or different from that of another population.

In certain embodiments, a powder can comprise a combination of two or more populations of particles, wherein at least two of the populations of particles are capable of emitting light having an emission wavelength that is distinct from each other.

In certain embodiments, a powder can comprise a combination of two or more populations of particles, wherein each of the two or more populations of particles are capable of emitting light having an emission wavelength that is distinct from each other.

A powder can have a predetermined particle size distribution.

In certain embodiments, a population of particles can be monomodal.

In certain embodiments, a population of particles can be multimodal.

A predetermined particles size distribution can be achieve by screening or by other techniques readily ascertainable by one of ordinary skill in the relevant art.

In accordance with another aspect of the invention, there is provided a formulation comprising a composition in accordance with the present invention and a solid or liquid medium.

In certain embodiments, a formulation can comprise a two or more compositions taught herein, which can be the same or different.

In certain embodiments, a composition can be included in the formulation in the form of a powder taught herein.

In certain embodiments, a formulation can include one or more monomers, polymers, resins, and/or other film forming compositions.

In certain embodiments, a formulation can optionally further include one or more components, including, but not limited to, phosphors, colorants, scatterers, binders, surfactants, defoaming agents, UV absorbers, etc.

In certain embodiments, the composition is not chemically reactive with the other ingredients included in the formulation.

In certain embodiments wherein at least a portion of the quantum dots include ligands attached to the outer surface thereof, the host material is selected to be chemically compatible with the ligands.

In certain embodiments, it may be desirable to have a formulation including quantum dot emissions at two or more distinct predetermined wavelengths. In such case two or more chemically and/or physically distinct quantum dots can be included in the formulation, wherein each of the distinct quantum dots has a composition, size, and/or structure selected to achieve the desired predetermined wavelength emission. The two or more chemically and/or physically distinct quantum dots can be included in one or more compositions that are included in the formulation.

Selection of a solid and/or liquid medium for use in a formulation can be readily made by one of ordinary skill in the art based on the intended use or application.

In certain embodiments, the liquid medium can be a polar or non-polar.

In certain embodiments, the liquid medium can comprise an aqueous solvent.

In certain embodiments, the liquid medium comprises a non-aqueous or organic solvent.

In certain embodiments, volatile liquids or mixtures of volatile liquids can be used.

Examples of liquid medium include, without limitation, toluene, xylene, acetone, butyl cellusolve, MEK, butyl alcohol, methyl amyl ketone, other organic solvents, and mixtures of one or more of any of the foregoing.

In certain embodiments, a solid medium can comprise a polymer.

In certain embodiments, a solid medium can comprise a resin.

Examples of other solid media also include, without limitation, any of the host materials and second host materials described herein.

Examples of other liquid media also include, without limitation, any other liquid media described herein.

In certain embodiments, a formulation can further include one or more other components. In certain embodiments, the one or more other components can include a pigment or colorant, a scatterer, a binder, a surfactant, a UV absorber, and/or a mixture of one or more thereof. Any of the additives or additional additives described herein can also be included in a formulation.

In certain embodiments, components can be selected based on the intended end-use application. Such selection of additives and/or other components can be readily ascertained by one of ordinary skill in the relevant art.

In accordance with another aspect of the invention, there is provided a coating comprising one or more compositions in accordance with the invention.

In certain embodiments, a coating can comprise a two or more compositions taught herein, which can be the same or different.

In certain embodiments, a composition can be included in the coating in the form of a powder taught herein.

In certain embodiments, a coating can optionally further include one or more components, including, but not limited to, phosphors, colorants, scatterers, binders, surfactants, UV absorbers, etc.

A coating can be prepared by applying one or more formulations in accordance with the present invention to a surface.

In certain embodiments, e.g., in which the formulation includes a liquid medium, a coating can be formed by removing the liquid by, for example, heating, evaporation with use of heat, without use of heat, cooling, curing, etc. The nature/properties of the liquid medium that may be included in the formulation will be a factor in selection of a technique that may be used to form the coating.

In certain embodiments, e.g., in which the formulation includes a solid medium, a coating can be formed by melt-casting, rubbing, spreading, etc. The nature/properties of the solid medium that may be included in the formulation will be a factor in selection of a technique that may be used to form the coating.

In accordance with a further aspect of the present invention, there is provided a device comprising one or more compositions of the invention.

Compositions, particles, powders, formulations, and coatings in accordance with various aspects and embodiments of the invention may be incorporated into a wide variety of consumer products, including flat panel displays, computer monitors, televisions, billboards, lights for interior or exterior illumination and/or signaling, heads up displays, fully transparent displays, flexible displays, laser printers, telephones, cell phones, personal digital assistants (PDAs), laptop computers, digital cameras, camcorders, viewfinders, micro-displays, vehicles, a large area wall, theater or stadium screen, a sign, lamps and various solid state lighting devices.

In accordance with another aspect of the present invention there is provided a taggant comprising a composition of the invention. A composition in accordance with the invention can be included in a taggant, e.g., to identify or mark an object, labels, maps, barcodes, instructions, etc. An amount of taggant comprising a composition can be applied to a surface to create one or more pre-selected colors that are detectable upon ultraviolet or visible excitation. Detection of the pre-selected color may be possible either by eye or with a detector. This photoluminescence detected can be in the visible or the infrared spectrums since fluorescence is a phenomenon not limited to the visible but rather can also occur in the infrared portion of the spectrum.

For example, in certain embodiments, multiple quantum dots with differing emission wavelengths can be included in the composition to provide coding capability for generating, for example, a predetermined code. The intensity of the quantum dot emission will depend on the number of quantum dots. Examining the spectral intensity and wavelength of the peaks can generate unique codes. Filters (e.g., bandpass filters) can be used in viewing the quantum dot emission to discriminate between different quantum dot emission wavelengths. By varying the quantum dot constituents and varying the concentration thereof in the composition, different codes can be generated.

In certain embodiments, a taggant can comprise a combination of two or more compositions.

A taggant may be included in the form of a crayon, marking stick or pencil, chalk-powder or other dry powder marking form (e.g., chalk-line), a spray, etc. The selection of the form in which a taggant may be included will depend on the intended end-use application.

In accordance with yet another aspect of the present invention, there is provided a method for preparing a composition of the invention. The method comprises melting a host material comprising a wax and mixing quantum dots and one or more of the above-listed additives therewith.

In certain embodiments, the method comprises melting a ChapStick® formulation and mixing quantum dots therewith.

In certain preferred embodiments, the method is carried out at a temperature that is not detrimental to the quantum dots or any ligand group(s) that may be further attached thereto.

In certain embodiments, the quantum dots are added as a dispersion of quantum dots in a volatilizable liquid. In such embodiments, the method further includes removing the volatilizable liquid. In certain embodiments, the volatilizable liquid is removed by heating or reducing the pressure of the admixture

In certain embodiments, the method is carried out under reduced pressure (e.g., 1 to 1000 mtorr).

The following examples are given to illustrate the nature of the invention. It should be understood, however, that the present invention is not to be limited to the specific conditions or details set forth in these examples.

### EXAMPLES

### Example 1

### Preparation of Semiconductor Nanocrystals Capable of Emitting Red Light with 3,5-di-tert-butyl-4-hydroxybenzylphosphonic acid

### A. Preparation of CdSe Cores:

29.9 mmol cadmium acetate was dissolved in 436.7 mmol of tri-n-octylphosphine at 100° C. in a 250 mL 3-neck round-bottom flask and then dried and degassed for one hour. 465.5 mmol of trioctylphosphine oxide and 61.0 mmol of octadecylphosphonic acid were added to a 0.5 L glass reactor and dried and degassed at 140° C. for one hour. After degassing, the Cd solution was added to the reactor containing the oxide/acid and the mixture was heated to 270° C. under nitrogen. Once the temperature reached 270° C., 8 mmol of tri-n-butylphosphine was injected into the flask. The temperature was brought back to 270° C. where 34 mL of 1.5 M TBP-Se was then rapidly injected. The reaction mixture was heated at 270° C. for approximately 30 minutes while aliquots of the solution were removed periodically in order to monitor the growth of the nanocrystals. Once the first absorption peak of the nanocrystals reached 567 nm, the reaction was stopped by cooling the mixture to room temperature. The CdSe cores were precipitated out of the growth solution inside a nitrogen atmosphere glovebox by adding a 3:1 mixture of methanol and isopropanol. The isolated cores were then dispersed in hexane.

B. Overcoating of CdSe Cores with CdZnS

517.3 mmol of trioctylphosphine oxide and 48.3 mmol of 3,5-di-tert-butyl-4-hydroxybenzylphosphonic acid were loaded into a 0.5 L glass reactor. The mixture was then dried and degassed in the reactor by heating to 120° C. for about an hour. The reactor was then cooled to 70° C. and the hexane solution containing isolated CdSe cores (1.98 mmol Cd content) was added to the reaction mixture. The hexane was removed under reduced pressure. Dimethyl cadmium, diethyl zinc, and hexamethyldisilathiane were used as the Cd, Zn, and S precursors, respectively. The Cd and Zn were mixed in equimolar ratios while the S was in two-fold excess relative to the Cd and Zn. The Cd/Zn and S samples were each dissolved in 80 mL of trioctylphosphine inside a nitrogen atmosphere glove box. Once the precursor solutions were prepared, the reaction flask was heated to 155° C. under nitrogen. The precursor solutions were added dropwise over the course of 2 hours at 155° C. using a syringe pump. After the shell growth, the nanocrystals were transferred to a nitrogen atmosphere glovebox and precipitated out of the growth solution by adding a 3:1 mixture of methanol and isopropanol. The isolated core-shell nanocrystals were then dissolved in chloroform and used to make quantum dot composite materials.

### Example 2

### Preparation of Composition Including Quantum Dots (Prepared Substantially in Accordance with the Procedure Described in Example 1) Distributed in a Host Material Comprising ChapStick® Classic Original

A 500 mL, half-jacketed three-necked flask with bottom teflon drain valve and equipped with a rotor-stator mixer and nitrogen inlet was heated via a recirculating heater set to 80° C. 66.4 g of ChapStick® (Classic Original, lot code #C39002) was transferred to the reactor under a nitrogen flow. The ChapStick® melted in about 20 minutes and reached a temperature of 58° C. as measured by an immersion thermocouple. The rotor-stator dispersive mixer was then switched on to allow mixing of the molten ChapStick®.

To this was added via syringe 46.9 mL of a dispersion of cadmium selenide/cadmium zinc sulfide core/shell quantum dots in chloroform. The concentration of the dispersion was 28 mg/mL on a metals basis. The quantum dots were prepared substantially in accordance with the procedure of Example 1 (QD Vision—#CdSeCS-038-020409). Quantum dots are overcoated with cadmium zinc sulfide layer as well as an organic ligand layer containing 3,5-di-t-butyl-4-hydroxybenzyl phosphonic acid. (BHT)).

The quantum dot dispersion was added to the molten ChapStick® over a 10 minute period in 10 mL aliquots to allow boil-off of the chloroform solvent from the molten mixture.

The quantum dot/ChapStick® mixture is allowed to disperse for an additional 5 minutes during which time all boiling ceased. The bottom drain valve was carefully opened and the molten ChapStick®-quantum dot mixture was cast into empty applicator containers which were then set aside and allowed to harden and cool at room temperature.

A stripe of the resultant composition of Example 2 (comprising quantum dots dispersed in ChapStick®) was applied to a surface of a glass microscope slide from the applicator (using a motion similar to that used to apply a crayon stripe to a surface). The stripe was illuminated with a 365 nm diode illuminator. The stripe on the marked glass emitted a strong red glow.

### Example 3

### InP/ZnSe Core/Shell Semiconductor Nanocrystals

### A. Reagents & Solvents

Table of Reagents & Solvents

| | CAS | FW | moles | |
|---|---|---|---|---|
| Compound | number | (g/mol) | (mmol) | amount |
| Indium phosphide Core | | | 1.05 | |
| Diethylzinc | 557-20-0 | 123.51 | 11.9 | 616 mg/ |
| | | | | 518 ul |
| 2 M trioctylphosphine | | n/a | 4.9 | 2.52 ml |
| selenide | | | | |
| Oleylamine | 112-90-3 | 267.49 | 42.56 | 14.0 ml |
| Squalane | 111-01-3 | 422.81 | | 63.0 ml |
| Methylmyristate | 124-10-7 | 242.41 | | 35.0 ml |

### General Preparation of Reagents, Solvents

All reagents and solvents are kept in a glove box after appropriate air-free treatment. Standard glove box and Schlenk techniques are used unless mentioned. Diethylzinc is filtered through a 0.2 μm syringe filter prior to use and kept in freezer. Methylmyristate and oleylamine are distilled under vacuum, and squalane is degassed under vacuum at high temperature prior to use. 2M trioctylphosphine selenide (TOP-Se) is prepared by dissolving selenium shot in trioctylphosphine.

### B. Preparation of InP Cores

35 ml of squalane and 35 ml of methylmyristate are transferred into the pot which has been preheated at 100° C. and evacuated for 30 min. (The setup includes 4-neck, 250 mL round bottom flask equipped with a stir bar inside, whose two necks are connected to a thermocouple temperature probe and a condenser with N₂/vacuum inlet/outlet and the rest two necks are stopped by septa. All connections are standard 14/20 ground glass joints lubricated with silicone grease—except septa. The flask is heated with a heating mantle connected to a digital temperature controller.) The solvent is degassed at 75° C. for one hour and is then placed under N₂ atmosphere.

C. Overcoating of InP Cores with ZnSe

The InP solution in n-hexane is prepared in a glove box and syringed into the pot containing the degassed solvent. n-Hexane is removed by vacuum at 75° C. for one hour and then the pot is placed back under N₂ atmosphere. Meanwhile removing residual hexane, Zn and Se precursor solutions are prepared in a glove box. The calculated amount of 2M TOP-Se is measured out in one vial and loaded into a 20 ml syringe, diluting with squalane up to the total volume of 14.0 ml forming the selenide precursor solution. The corresponding amount of diethylzinc is measured in a vial and loaded into another 20 ml syringe with squalane forming total 14.0 ml of zinc precursor solution. When the pot is under N₂ atmosphere at 75° C. without residual n-hexane, two precursor syringes are taken out from a glove box and connected to capillaries and then loaded to a syringe pump. The two ends of capillaries are plunged to the pots until they touch the surface of the solution so that the precursor solution can get into solution without making a drop. The temperature is set to 200° C., and once it reaches to 170° C. precursor solutions are injected at the rate of 14 ml/hr. A few minutes later when the temperature is at 200° C., inject 14 ml of oleylamine with continuous injection of precursors. After the addition of all precursors, the temperature is set to 150° C. and stayed overnight under N₂ atmosphere. The reaction is then syringed into an evacuated, septum-capped vial for transport into a glove box.

Upon cooling, a flocculent, reddish solid precipitates out of the red reaction mixture. The reaction mixture is reheated to 70° C. to redissolve the solid, forming a red, homogenous solution. The mixture is diluted with 140 ml n-hexane and cooled down long enough the solid to precipitate. After being centrifuged (4000 rpm for 8 min), the red supernatant is decanted and collected and the reddish solids are washed with 70 ml of n-hexane and centrifuged again. The supernatant is decanted off and added to the first fraction. 140 ml of n-butanol is added to the red nanocrystal solution followed by enough methanol to make the solution turbid (typically ˜140 ml). The turbid solution is then centrifuged and the supernatant is decanted and discarded. The reddish solid left behind is dissolved in 35 ml n-hexane and filtered through a 0.2 μm PTFE syringe filter. Optical properties are obtained in dilute n-hexane solution. The quantum yield is ˜48%.

### Example 4

### Preparation of Composition Including Quantum Dots (Prepared Substantially in Accordance with the Procedure Described in Example 3) Distributed in a Host Material Comprising ChapStick® Classic Original

A 20 mL, glass vial equipped with a magnetic Teflon stirrer and a silicone rubber septum top was charged with 4.1 g of ChapStick® (Classic Original, lot code #C39002). The vial was sealed, and inerted by evacuating and refilling the vial 3 times via a syringe needle connected to a vacuum/inert gas manifold. After inerting, the vial, still under vacuum (ca. 100 mtorr) was placed on a hot plate which was set to a 100° C. surface temperature. As the wax melted, stirring was begun.

To the fully melted wax was added via syringe 12 mL of a dispersion of InP/ZnSe core/shell quantum dots in hexanes. The concentration of the dispersion was 13 mg/mL on a metals basis. The quantum dots were prepared substantially in accordance with the procedure of Example 3

The quantum dot dispersion was added to the molten ChapStick® over a 10 minute period in small aliquots to allow boil-off of the hexanes solvent from the molten mixture.

The quantum dot/ChapStick® mixture was allowed to mix for an additional 10 minutes during which time all boiling ceased and the pressure began to fall below 1000 mtorr, indicating all solvent had been removed. The molten ChapStick®-quantum dot mixture was cast into empty applicator containers which were then set aside and allowed to harden and cool at room temperature.

### Example 5

### Preparation of Composition Including Quantum Dots (Prepared Substantially in Accordance with the Procedure Described in Example 3) Distributed in a Host Material Comprising Beeswax

A 20 mL, glass vial equipped with a magnetic Teflon stirrer and a silicone rubber septum top was charged with 4.1 g white beeswax (Aldrich, lot code #02703TD). The vial was sealed, and inerted by evacuating and refilling the vial 3 times via a syringe needle connected to a vacuum/inert gas manifold. After inerting, the vial, still under vacuum (ca. 100 mtorr) was placed on a hot plate which was set to a 100° C. surface temperature. As the wax melted, stirring was begun.

To the fully melted wax was added via syringe 12 mL of a dispersion of InP/ZnSe core/shell quantum dots in hexane. The concentration of the dispersion was 13 mg/mL on a metals basis. The quantum dots were prepared substantially in accordance with the procedure of Example 3

The quantum dot dispersion was added to the molten beeswax over a 10 minute period in small aliquots to allow boil-off of the hexanes solvent from the molten mixture.

The quantum dot/beeswax mixture was allowed to mix for an additional 10 minutes during which time all boiling ceased and the pressure began to fall below 1000 mtorr, indicating all solvent had been removed. The molten beeswax-quantum dot mixture was cast into empty applicator containers which were then set aside and allowed to harden and cool at room temperature.

### EQE Measurements for Compositions of Examples 4 & 5

### Sample 4CS

A glass microscope slide was modified by bordering with 1 mil thick Kapton tape as a spacer. A stripe of the resultant composition of Example 4 (comprising quantum dots dispersed in ChapStick®) was applied to a surface of the glass microscope slide from the applicator (using a motion similar to that used to apply a crayon stripe to a surface) and then drawn into a thin film using a razor blade. The Kapton tape was then removed, leaving a smooth, thin film of wax composition on the slide.

### Sample 5BW

A glass microscope slide was modified by bordering with 1 mil thick Kapton tape as a spacer. A stripe of the resultant composition of Example 5 (comprising quantum dots dispersed in beeswax) was applied to a surface of the glass microscope slide from the applicator (using a motion similar to that used to apply a crayon stripe to a surface) and then drawn into a thin film using a razor blade. The Kapton tape was then removed, leaving a smooth, thin film of wax composition on the slide.

EQE measurements were taken at Time A and three months later (Time B) using a blue diode at 450 nm and 1000 mW power.

The data for Samples 5BW and 4CS are included in the following Table:

| Sample | Host Material | Date | Absorbance | EQE |
|---|---|---|---|---|
| 5BW | Beeswax | Time A | 0.44 | 17% |
| 4CS | Chapstick | Time A | 0.48 | 14% |
| 5BW | Beeswax | Time B | 0.40 | 2% |
| 4CS | Chapstick | Time B | 0.29 | 12% |

The quantum dot samples in Beeswax lost 88% of their external quantum efficiency during the three month aging period while the samples including quantum dots in the ChapStick® formulation had lost only 14%. Sample 4CS (a composition comprising quantum dots dispersed in a ChapStick® formulation) demonstrated improved EQE performance compared to BW5.

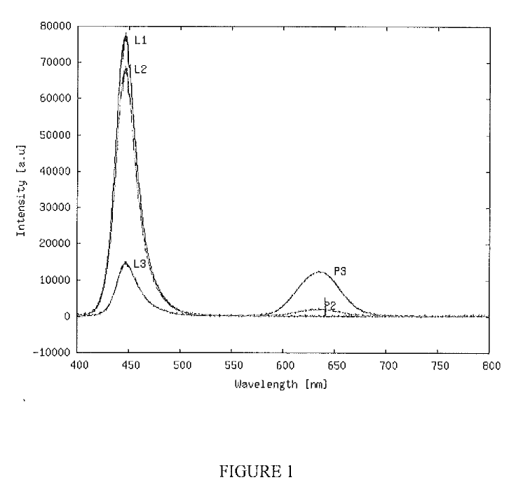

The external photoluminescent (PL) quantum efficiency is generally measured using the method developed by Mello et al., Advanced Materials 9(3):230 (1997), which is hereby incorporated herein by reference in its entirety. The method uses a collimated 450 nm LED source, an integrating sphere and a spectrometer. Three measurements are taken. First, the LED directly illuminates the integrating sphere giving the spectrum labeled L1 below. Next, the PL sample is placed into the integrating sphere so that only diffuse LED light illuminates the sample giving the (L2+P2) spectrum below. Finally, the PL sample is placed into the integrating sphere so that the LED directly illuminates the sample (just off normal incidence) giving the (L3+P3) spectrum. (See FIG. 1). After collecting the data, each spectral contribution (L's and P's) is computed. L1, L2 and L3 correspond to the sums of the LED spectra for each measurement and P2 and P3 are the sums associated with the PL spectra for 2nd and 3rd measurements. The following equation then gives the external PL quantum efficiency:

EQE=[(P3•L2)minus(P2•L3)]/(L1•(L2 minus L3))

Quantum dots included in the various aspects and embodiments of the inventions within the scope of this application can have an average particle size in a range from about 1 to about 1000 nanometers (nm), and preferably in a range from about 1 to about 100 nm. In certain embodiments, quantum dots have an average particle size in a range from about 1 to about 20 nm. In certain embodiments, quantum dots have an average particle size in a range from about 1 to about 10 nm.

Preferably, a quantum dot comprises a semiconductor nanocrystal. In certain embodiments, a semiconductor nanocrystal has an average particle size in a range from about 1 to about 20 nm, and preferably from about 1 to about 10 nm.

A quantum dot (e.g., semiconductor nanocrystal) can comprise one or more semiconductor materials.

Examples of semiconductor materials that be included in a quantum dot (e.g., semiconductor nanocrystal) include a Group IV element, a Group II-VI compound, a Group II-V compound, a Group III-VI compound, a Group III-V compound, a Group IV-VI compound, a Group I-III-VI compound, a Group II-IV-VI compound, a Group II-IV-V compound, an alloy including any of the foregoing, and/or a mixture including any of the foregoing, including ternary and quaternary mixtures or alloys. A non-limiting list of examples include ZnO, ZnS, ZnSe, ZnTe, CdO, CdS, CdSe, CdTe, MgS, MgSe, GaAs, GaN, GaP, GaSe, GaSb, HgO, HgS, HgSe, HgTe, InAs, InN, InP, InSb, AlAs, AlN, AlP, AlSb, TlN, TlP, TlAs, TlSb, PbO, PbS, PbSe, PbTe, Ge, Si, an alloy including any of the foregoing, and/or a mixture including any of the foregoing, including ternary and quaternary mixtures or alloys.

In certain embodiments, quantum dots can comprise semiconductor nanocrystals including a core comprising a first semiconductor material and a shell comprising a second semiconductor material, wherein the shell is disposed over at least a portion of a surface of the core. A quantum dot (e.g., semiconductor nanocrystal) including a core and shell is also referred to as a “core/shell” structure.

For example, the quantum dot (e.g., semiconductor nanocrystal) can include a core having the formula MX, where M is cadmium, zinc, magnesium, mercury, aluminum, gallium, indium, thallium, or mixtures thereof, and X is oxygen, sulfur, selenium, tellurium, nitrogen, phosphorus, arsenic, antimony, or mixtures thereof. Examples of materials suitable for use as quantum dot (e.g., semiconductor nanocrystal) cores include, but are not limited to, ZnO, ZnS, ZnSe, ZnTe, CdO, CdS, CdSe, CdTe, MgS, MgSe, GaAs, GaN, GaP, GaSe, GaSb, HgO, HgS, HgSe, HgTe, InAs, InN, InP, InSb, AlAs, AlN, AlP, AlSb, TlN, TlP, TlAs, TlSb, PbO, PbS, PbSe, PbTe, Ge, Si, an alloy including any of the foregoing, and/or a mixture including any of the foregoing, including ternary and quaternary mixtures or alloys.

The shell can be a semiconductor material having a composition that is the same as or different from the composition of the core. The shell comprises an overcoat of a semiconductor material on a surface of the core quantum dot (e.g., semiconductor nanocrystal) can include a Group IV element, a Group II-VI compound, a Group II-V compound, a Group III-VI compound, a Group III-V compound, a Group IV-VI compound, a Group I-III-VI compound, a Group II-IV-VI compound, a Group II-IV-V compound, alloys including any of the foregoing, and/or mixtures including any of the foregoing, including ternary and quaternary mixtures or alloys. Examples include, but are not limited to, ZnO, ZnS, ZnSe, ZnTe, CdO, CdS, CdSe, CdTe, MgS, MgSe, GaAs, GaN, GaP, GaSe, GaSb, HgO, HgS, HgSe, HgTe, InAs, InN, InP, InSb, AlAs, AlN, AlP, AlSb, TlN, TlP, TlAs, TlSb, PbO, PbS, PbSe, PbTe, Ge, Si, an alloy including any of the foregoing, and/or a mixture including any of the foregoing. For example, ZnS, ZnSe or CdS overcoatings can be grown on CdSe or CdTe semiconductor nanocrystals.

In a core/shell quantum dot (e.g., semiconductor nanocrystal), the shell or overcoating may comprise one or more layers. The overcoating can comprise at least one semiconductor material which is the same as or different from the composition of the core. Preferably, the overcoating has a thickness from about one to about ten monolayers. An overcoating can also have a thickness greater than ten monolayers. In certain embodiments, more than one overcoating can be included on a core.

In certain embodiments, the surrounding “shell” material can have a band gap greater than the band gap of the core material. In certain other embodiments, the surrounding shell material can have a band gap less than the band gap of the core material.

In certain embodiments, the shell can be chosen so as to have an atomic spacing close to that of the “core” substrate. In certain other embodiments, the shell and core materials can have the same crystal structure.

Examples of quantum dot (e.g., semiconductor nanocrystal) (core)shell materials include, without limitation: red (e.g., (CdSe)ZnS (core)shell), green (e.g., (CdZnSe)CdZnS (core)shell, etc.), and blue (e.g., (CdS)CdZnS (core)shell.

Examples of the shape of semiconductor nanocrystals and other quantum dots can include sphere, rod, disk, other shapes or mixtures thereof.

One example of a method of manufacturing a quantum dot (e.g., semiconductor nanocrystal) is a colloidal growth process. Colloidal growth occurs by injection an M donor and an X donor into a hot coordinating solvent. One example of a preferred method for preparing monodisperse quantum dots (e.g., semiconductor nanocrystals) comprises pyrolysis of organometallic reagents, such as dimethyl cadmium, injected into a hot, coordinating solvent. This permits discrete nucleation and results in the controlled growth of macroscopic quantities of quantum dots (e.g., semiconductor nanocrystals). The injection produces a nucleus that can be grown in a controlled manner to form a quantum dot (e.g., semiconductor nanocrystal). The reaction mixture can be gently heated to grow and anneal the quantum dot (e.g., semiconductor nanocrystal). Both the average size and the size distribution of the quantum dots (e.g., semiconductor nanocrystals) in a sample are dependent on the growth temperature. The growth temperature necessary to maintain steady growth increases with increasing average crystal size. The quantum dot (e.g., semiconductor nanocrystal) is a member of a population of quantum dots (e.g., semiconductor nanocrystals). As a result of the discrete nucleation and controlled growth, the population of quantum dots (e.g., semiconductor nanocrystals) that can be obtained has a narrow, monodisperse distribution of diameters. The monodisperse distribution of diameters can also be referred to as a size. Preferably, a monodisperse population of particles includes a population of particles wherein at least about 60% of the particles in the population fall within a specified particle size range. A population of monodisperse particles preferably deviate less than 15% rms (root-mean-square) in diameter and more preferably less than 10% rms and most preferably less than 5%.

An overcoating process is described, for example, in U.S. Pat. No. 6,322,901. By adjusting the temperature of the reaction mixture during overcoating and monitoring the absorption spectrum of the core, over coated materials having high emission quantum efficiencies and narrow size distributions can be obtained.

The narrow size distribution of the quantum dots (e.g., semiconductor nanocrystals) allows the possibility of light emission in narrow spectral widths. Monodisperse semiconductor nanocrystals have been described in detail in Murray et al. (J. Am. Chem. Soc., 115:8706 (1993)); in the thesis of Christopher Murray, and “Synthesis and Characterization of II-VI Quantum Dots and Their Assembly into 3-D Quantum Dot Superlattices”, Massachusetts Institute of Technology, September, 1995. The foregoing are hereby incorporated herein by reference in their entireties.

The process of controlled growth and annealing of the quantum dots (e.g., semiconductor nanocrystals) in the coordinating solvent that follows nucleation can also result in uniform surface derivatization and regular core structures. As the size distribution sharpens, the temperature can be raised to maintain steady growth. By adding more M donor or X donor, the growth period can be shortened. The M donor can be an inorganic compound, an organometallic compound, or elemental metal. M is cadmium, zinc, magnesium, mercury, aluminum, gallium, indium or thallium. The X donor is a compound capable of reacting with the M donor to form a material with the general formula MX. The X donor can be a chalcogenide donor or a pnictide donor, such as a phosphine chalcogenide, a bis(silyl) chalcogenide, dioxygen, an ammonium salt, or a tris(silyl) pnictide. Suitable X donors include dioxygen, bis(trimethylsilyl) selenide ((TMS)₂Se), trialkyl phosphine selenides such as (tri-noctylphosphine) selenide (TOPSe) or (tri-n-butylphosphine) selenide (TBPSe), trialkyl phosphine tellurides such as (tri-n-octylphosphine) telluride (TOPTe) or hexapropylphosphorustriamide telluride (HPPTTe), bis(trimethylsilyl)telluride ((TMS)₂Te), bis(trimethylsilyl)sulfide ((TMS)₂S), a trialkyl phosphine sulfide such as (tri-noctylphosphine) sulfide (TOPS), an ammonium salt such as an ammonium halide (e.g., NH₄Cl), tris(trimethylsilyl) phosphide ((TMS)₃P), tris(trimethylsilyl) arsenide ((TMS)₃As), or tris(trimethylsilyl) antimonide ((TMS)₃Sb). In certain embodiments, the M donor and the X donor can be moieties within the same molecule.

A coordinating solvent can help control the growth of the quantum dot (e.g., semiconductor nanocrystal). The coordinating solvent is a compound having a donor lone pair that, for example, has a lone electron pair available to coordinate to a surface of the growing quantum dot (e.g., semiconductor nanocrystal). Solvent coordination can stabilize the growing quantum dot (e.g., semiconductor nanocrystal). Examples of coordinating solvents include alkyl phosphines, alkyl phosphine oxides, alkyl phosphonic acids, or alkyl phosphinic acids, however, other coordinating solvents, such as pyridines, furans, and amines may also be suitable for the quantum dot (e.g., semiconductor nanocrystal) production. Additional examples of suitable coordinating solvents include pyridine, tri-n-octyl phosphine (TOP), tri-n-octyl phosphine oxide (TOPO) and trishydroxylpropylphosphine (tHPP), tributylphosphine, tri(dodecyl)phosphine, dibutyl-phosphite, tributyl phosphite, trioctadecyl phosphite, trilauryl phosphite, tris(tridecyl) phosphite, triisodecyl phosphite, bis(2-ethylhexyl)phosphate, tris(tridecyl) phosphate, hexadecylamine, oleylamine, octadecylamine, bis(2-ethylhexyl)amine, octylamine, dioctylamine, trioctylamine, dodecylamine/laurylamine, didodecylamine tridodecylamine, hexadecylamine, dioctadecylamine, trioctadecylamine, phenylphosphonic acid, hexylphosphonic acid, tetradecylphosphonic acid, octylphosphonic acid, octadecylphosphonic acid, propylenediphosphonic acid, phenylphosphonic acid, aminohexylphosphonic acid, dioctyl ether, diphenyl ether, methyl myristate, octyl octanoate, and hexyl octanoate. In certain embodiments, technical grade TOPO can be used.

Size distribution during the growth stage of the reaction can be estimated by monitoring the absorption or emission line widths of the particles. Modification of the reaction temperature in response to changes in the absorption spectrum of the particles allows the maintenance of a sharp particle size distribution during growth. Reactants can be added to the nucleation solution during crystal growth to grow larger crystals. For example, for CdSe and CdTe, by stopping growth at a particular semiconductor nanocrystal average diameter and choosing the proper composition of the semiconducting material, the emission spectra of the semiconductor nanocrystals can be tuned continuously over the wavelength range of 300 nm to 5 microns, or from 400 nm to 800 nm.

The particle size distribution of the quantum dots (e.g., semiconductor nanocrystals) can be further refined by size selective precipitation with a poor solvent for the quantum dots (e.g., semiconductor nanocrystals), such as methanol/butanol. For example, quantum dots (e.g., semiconductor nanocrystals) can be dispersed in a solution of 10% butanol in hexane. Methanol can be added dropwise to this stirring solution until opalescence persists. Separation of supernatant and flocculate by centrifugation produces a precipitate enriched with the largest crystallites in the sample. This procedure can be repeated until no further sharpening of the optical absorption spectrum is noted. Size-selective precipitation can be carried out in a variety of solvent/nonsolvent pairs, including pyridine/hexane and chloroform/methanol. The size-selected quantum dot (e.g., semiconductor nanocrystal) population preferably has no more than a 15% rms deviation from mean diameter, more preferably 10% rms deviation or less, and most preferably 5% rms deviation or less.

As mentioned above, in certain embodiments, quantum dots (e.g., semiconductor nanocrystals) preferably have ligands attached thereto.

In certain embodiment, the ligands can be derived from the coordinating solvent used during the growth process. The surface can be modified by repeated exposure to an excess of a competing coordinating group to form an overlayer. For example, a dispersion of the capped quantum dot (e.g., semiconductor nanocrystal) can be treated with a coordinating organic compound, such as pyridine, to produce crystallites which disperse readily in pyridine, methanol, and aromatics but no longer disperse in aliphatic solvents. Such a surface exchange process can be carried out with any compound capable of coordinating to or bonding with the outer surface of the quantum dot (e.g., semiconductor nanocrystal), including, for example, phosphines, thiols, amines and phosphates. The quantum dot (e.g., semiconductor nanocrystal) can be exposed to short chain polymers which exhibit an affinity for the surface and which terminate in a moiety having an affinity for a liquid medium in which the quantum dot (e.g., semiconductor nanocrystal) is suspended or dispersed. Such affinity improves the stability of the suspension and discourages flocculation of the quantum dot (e.g., semiconductor nanocrystal). In certain embodiments, quantum dots (e.g., semiconductor nanocrystals) can alternatively be prepared with use of non-coordinating solvent(s).

In certain embodiments, the coordinating ligand can have the formula:

(Y—)ₖ₋ₙ—(X)-(-L)ₙ

wherein k is 2, 3 4, or 5, and n is 1, 2, 3, 4 or 5 such that k-n is not less than zero; X is O, O—S, O—Se, O—N, O—P, O—As, S, S═O, SO2, Se, Se═O, N, N═O, P, P═O, C═O As, or As═O; each of Y and L, independently, is H, OH, aryl, heteroaryl, or a straight or branched C2-18 hydrocarbon chain optionally containing at least one double bond, at least one triple bond, or at least one double bond and one triple bond. The hydrocarbon chain can be optionally substituted with one or more C1-4 alkyl, C2-4 alkenyl, C2-4 alkynyl, C1-4 alkoxy, hydroxyl, halo, amino, nitro, cyano, C3-5 cycloalkyl, 3-5 membered heterocycloalkyl, aryl, heteroaryl, C1-4 alkylcarbonyloxy, C1-4 alkyloxycarbonyl, C1-4 alkylcarbonyl, or formyl. The hydrocarbon chain can also be optionally interrupted by —O—, —S—, —N_{(Ra)}, —N_{(Ra)}—C(O)—O—, —O—C(O)—N(Ra)—, —N_{(Ra)}—C(O)—N_{(Rb)}—, —O—C(O)—O—, —P_{(Ra)}—, or —P(O)_{(Ra)}. Each of Ra and Rb, independently, is hydrogen, alkyl, alkenyl, alkynyl, alkoxy, hydroxylalkyl, hydroxyl, or haloalkyl. An aryl group is a substituted or unsubstituted cyclic aromatic group. Examples include phenyl, benzyl, naphthyl, tolyl, anthracyl, nitrophenyl, or halophenyl. A heteroaryl group is an aryl group with one or more heteroatoms in the ring, for instance furyl, pyridyl, pyrrolyl, phenanthryl.

A suitable coordinating ligand can be purchased commercially or prepared by ordinary synthetic organic techniques, for example, as described in J. March, Advanced Organic Chemistry, which is hereby incorporated by reference in its entirety.

Other ligands are described in U.S. patent application Ser. No. 10/641,292 for “Stabilized Semiconductor Nanocrystals”, filed 15 Aug. 2003, which issued on 9 Jan. 2007 as U.S. Pat. No. 7,160,613, which is hereby incorporated herein by reference in its entirety.

The emission from a quantum dot capable of emitting light (e.g., a semiconductor nanocrystal) can be a narrow Gaussian emission band that can be tuned through the complete wavelength range of the ultraviolet, visible, or infra-red regions of the spectrum by varying the size of the quantum dot, the composition of the quantum dot, or both. For example, a semiconductor nanocrystal comprising CdSe can be tuned in the visible region; a semiconductor nanocrystal comprising InAs can be tuned in the infra-red region. The narrow size distribution of a population of quantum dots capable of emitting light (e.g., semiconductor nanocrystals) can result in emission of light in a narrow spectral range. The population can be monodisperse preferably exhibits less than a 15% rms (root-mean-square) deviation in diameter of such quantum dots, more preferably less than 10%, most preferably less than 5%. Spectral emissions in a narrow range of no greater than about 75 nm, preferably 60 nm, more preferably 40 nm, and most preferably 30 nm full width at half max (FWHM) for such quantum dots that emit in the visible can be observed. IR-emitting quantum dots can have a FWHM of no greater than 150 nm, or no greater than 100 nm. Expressed in terms of the energy of the emission, the emission can have a FWHM of no greater than 0.05 eV, or no greater than 0.03 eV. The breadth of the emission decreases as the dispersity of the light-emitting quantum dot diameters decreases.

For example, semiconductor nanocrystals can have high emission quantum efficiencies such as greater than 10%, 20%, 30%, 40%, 50%, 60%, 70%, 80%, or 90%.

The narrow FWHM of semiconductor nanocrystals can result in saturated color emission. The broadly tunable, saturated color emission over the entire visible spectrum of a single material system is unmatched by any class of organic chromophores (see, for example, Dabbousi et al., J. Phys. Chem. 101, 9463 (1997), which is incorporated by reference in its entirety). A monodisperse population of semiconductor nanocrystals will emit light spanning a narrow range of wavelengths.

A pattern including more than one size of quantum dot (e.g., semiconductor nanocrystal) can emit light in more than one narrow range of wavelengths. The color of emitted light perceived by a viewer can be controlled by selecting appropriate combinations of quantum dot (e.g., semiconductor nanocrystal) sizes and materials. The degeneracy of the band edge energy levels of quantum dots (e.g., semiconductor nanocrystals) facilitates capture and radiative recombination of all possible excitons.

Transmission electron microscopy (TEM) can provide information about the size, shape, and distribution of the quantum dot (e.g., semiconductor nanocrystal) population. Powder X-ray diffraction (XRD) patterns can provide the most complete information regarding the type and quality of the crystal structure of the quantum dots (e.g., semiconductor nanocrystals). Estimates of size are also possible since particle diameter is inversely related, via the X-ray coherence length, to the peak width. For example, the diameter of the semiconductor nanocrystal can be measured directly by transmission electron microscopy or estimated from X-ray diffraction data using, for example, the Scherrer equation. It also can be estimated from the UV/Vis absorption spectrum.

Other materials, techniques, methods, applications, and information that may be useful with the present invention are described in International Application No. PCT/US2007/24320, filed Nov. 21, 2007, of Clough, et al., for “Nanocrystals Including A Group IIIa Element And A Group Va Element, Method, Composition, Device And Other Products” which published as WO2008/133660; U.S. Patent Application No. 60/971,887, filed Sep. 12, 2007, of Breen, et al., for “Functionalized Semiconductor Nanocrystals And Method”; U.S. Patent Application No. 60/992,598, filed Dec. 5, 2007, of Breen, et al., for “Functionalized Nanoparticles And Method”; International Application No. PCT/US2008/10651, of Breen, et al., for “Functionalized Nanoparticles And Method”, filed 12 Sep. 2008, International Application No. PCT/US2007/24305, filed Nov. 21, 2007, of Breen, et al., for “Blue Light Emitting Semiconductor Nanocrystal And Compositions And Devices Including Same” which published as WO2008/063652; International Application No. PCT/US2007/24306, filed Nov. 21, 2007, of Ramprasad, for “Semiconductor Nanocrystal And Compositions And Devices Including Same” which published as WO2008/063653; U.S. Patent Application No. 61/016,227, filed 21 Dec. 2007, of Coe-Sullivan et al., for “Compositions, Optical Component, System Including an Optical Component, and Devices”, International Application No. PCT/US2008/007901 of Linton, et al., for “Compositions And Methods Including Depositing Nanomaterial”, filed 25 Jun. 2008, U.S. patent application Ser. No. 12/283,609 of Seth Coe-Sullivan et al. for “Compositions, Optical Component, System Including An Optical Components, Devices, And Other Products”, filed 12 Sep. 2008, U.S. Patent Application No. 60/949,306, filed 12 Jul. 2007, of Linton, et al., for “Compositions, Methods For Depositing Nanomaterial, Methods For Fabricating A Device, And Methods For Fabricating An Array Of Devices”, International Application No. PCT/US2008/007901 of Linton, et al., for “Compositions And Methods Including Depositing Nanomaterial”, filed 25 Jun. 2008, International Application No. PCT/US2009/01372, filed 4 Mar. 2009, of John R. Linton, et al, for “Particles Including Nanoparticles, Uses Thereof, and Methods”, U.S. Pat. No. 7,470,731, issued Dec. 30, 2008, of Sanchez, et al., for “Fluorescent Ink”, U.S. Pat. No. 7,229,690, issued 12 Jun. 2007, of Chan, et al., for “Microspheres Including Nanoparticles”, U.S. Pat. No. 7,449,237, issued 11 Nov. 2008, of Chan, et al., for “Microspheres Including Nanoparticles in the Peripheral Region”, International Application No. PCT/US2009/01372, filed 4 Mar. 2009, of John R, Linton, et al, for “Particles Including Nanoparticles, Uses Thereof, and Methods”, U.S. Application No. 61/161,728, filed 19 Mar. 2009, of Robert Nick, for “Compositions Including Quantum Dots, Uses of the Foregoing, and Methods”, U.S. Application No. 61/162,223, filed 20 Mar. 2009, of Robert Nick, for “Compositions Including Quantum Dots, Uses of the Foregoing, and Methods”, and U.S. Patent Application No. 61/240,937, filed 9 Sep. 2009, of Robert Nick for “Formulations Including Nanoparticles. The disclosures of each of the foregoing listed patent documents are hereby incorporated herein by reference in their entireties.

As used herein, the singular forms “a”, “an” and “the” include plural unless the context clearly dictates otherwise. Thus, for example, reference to an emissive material includes reference to one or more of such materials.

Applicant specifically incorporates the entire contents of all cited references in this disclosure by reference in their entirety. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A composition comprising a host material including quantum dots and one or more of the following additives:
a terpene;
a fragrance;
a fatty acid ester emulsifier;
a fatty acid ester;
a high molecular weight alcohol;
an oxygen scavenger; and
a fatty alcohol.

2. A composition comprising a host material including quantum dots distributed therein, wherein the host material comprises a ChapStick® formulation.

3. A composition in accordance with claim 1 wherein the composition includes at least about 0.001 weight percent quantum dots.

4. A composition in accordance with claim 1 wherein the composition includes from about 0.01 to about 10 weight percent quantum dots.

5. A composition in accordance with claim 1 wherein the quantum dots are capable of emitting light at a predetermined wavelength.

6. A composition in accordance with claim 1 wherein the composition further comprises one or mare of the following additional additives:
a UV absorbing dye;
a humectant;
an occlusant;
a surfactant;
an antioxidant;
a pigment; and
a viscosity modifier.

7. A composition in accordance with claim 1 wherein at least a portion of the quantum dots comprise semiconductor nanocrystals.

8. A composition in accordance with claim 7 wherein at least a portion of the semiconductor nanocrystals include a core comprising a first semiconductor material and a shell disposed over at least a portion of a surface of the core, the shell comprising a second semiconductor material.

9. A composition in accordance with claim 1 wherein the composition includes two or more populations of quantum dots, wherein at least one population of quantum dots is capable of emitting light having an emission wavelength that is distinct from that emitted by at least one other population of quantum dots.

10. A composition in accordance with claim 9 wherein each of the populations of quantum dots is capable of emitting light having an emission wavelength that is distinct from that emitted by each of the other populations of quantum dots.

11. A particle comprising a composition in accordance with claim 1.

12. A particle in accordance with claim 11 wherein the particle has a size in a range from about 5 nm to about 100 microns.

13. A powder comprising a plurality of particles in accordance with claim 11.

14. A formulation comprising a composition in accordance with claim 1 and a solid or liquid medium.

15. A coating comprising a composition in accordance with claim 1.

16. A taggant comprising a composition in accordance with claim 1.

17. A device including a composition in accordance with claim 1.

18. A method for preparing a composition in accordance with claim 1 comprising melting a host material comprising wax and mixing quantum dots and one or more additives therewith.

19. A method in accordance with claim 18 wherein quantum dots are added as a dispersion of quantum dots in a volatilizable liquid.

20. A composition in accordance with claim 1 wherein the host material comprises wax.

21. A composition in accordance with claim 1 wherein the composition comprises a host material, quantum dots, and two or more of the following additives:
a terpene;
an occlusant;
an antioxidant;
a fatty acid ester emulsifier;
a fatty acid ester;
a high molecular weight alcohol;
an oxygen scavenger; and
a fatty alcohol

22. A composition in accordance with claim 21 wherein the composition further comprises a UV absorber, a humectant, a surfactant, a viscosity modifier, or a combination of any two or more of the foregoing.

23. A composition in accordance with claim 21 wherein the host material comprises wax.

24. A composition in accordance with claim 1 wherein the composition comprises a solid host material, quantum dots and two or more of the following additives:
a fatty acid ester emulsifier;
a fatty acid ester;
a high molecular weight alcohol; and
a fatty alcohol.

25. A composition in accordance with claim 24 wherein the composition further comprises a UV absorber, a humectant, a surfactant, a viscosity modifier, or a combination of any two or more of the foregoing.

26. A composition in accordance with claim 6 wherein the composition comprises a host material including quantum dots, a UV absorbing dye, a surfactant, a fatty acid emulsifier, an oxygen scavenger, and a viscosity modifier.

27. A composition in accordance with claim 1 wherein at least a portion of the quantum dots are included in the composition in the form of particles comprising quantum dots included in a second host material.

28. A composition in accordance with claim 27 wherein the composition includes a population of particles comprising quantum dots in a second host material having a predetermined particle size distribution.

29. A composition in accordance with claim 27 wherein the composition comprises two or more populations of particles, wherein at least one population of particles includes quantum dots that emit light at a wavelength that is distinct from that emitted by quantum dots included in another population of particles.

30. A particle in accordance with claim 11 wherein at least a portion of the quantum dots are included in the composition in the form of particles comprising quantum dots included in a second host material.

31. A powder in accordance with claim 13 wherein the composition included in at least a portion of the particles comprises quantum dots further included in a second host material.

32. A formulation in accordance with claim 14 wherein the composition includes particles comprising quantum dots further included in a second host material.

33. A coating in accordance with claim 15 wherein the composition includes particles comprising quantum dots further included in a second host material.

34. A taggant in accordance with claim 16 wherein the composition includes particles comprising quantum dots further included in a second host material.

35. A device in accordance with claim 17 wherein the composition includes particles comprising quantum dots further included in a second host material.

36. A method in accordance with claim 18 wherein at least a portion of the quantum dots are introduced in the form of particles comprising quantum dots further included in a second host material.

37. A composition in accordance with claim 5 wherein the predetermined wavelength is in the visible region of the spectrum.

38. A composition in accordance with claim 5 wherein the predetermined wavelength is in the infra-red region of the spectrum.
